(19) United States
(12) Patent Application Publication
(10) Pub. No.: US 2004/0194131 A1
(43) Pub. Date: Sep. 30, 2004

(54) Television system with scheduling of advertisements

(76) Inventors: Michael D. Ellis, Boulder, CO (US); Daniel C. Hagenbuch, Holland, PA (US)

Correspondence Address: FISH & NEAVE, 1251 AVENUE OF THE AMERICAS, 50TH FLOOR, NEW YORK, NY, 10020-1105, US

(21) Appl. No.: 10/823,985

(22) Filed: Apr. 13, 2004

Related U.S. Application Data
(63) Continuation of application No. 09/483,685, filed on Jan. 13, 2000, now abandoned.
(60) Provisional application No. 60/123,995, filed on Mar. 11, 1999.

(51) Int. Cl. H04N 7/025

(52) U.S. Cl. 725/34; 725/35

(57) ABSTRACT

A system is provided for scheduling interactive advertisements. The system may receive orders for the presentation of interactive advertisements and receive interactive advertisements in digital form. Interactive advertisements may be scheduled based on the received orders. The scheduling and display of interactive advertisements may be based on assigned priority, day part, category, rotation type, form, screen location, screen group, time zone, size, etc. The orders may include information on an advertisement customer's desired display parameters. Pricing for orders may be provided based on information in the order or based on system delivery rates.

This application is a continuation of U. S. Nonprovisional Application Ser. No. 09/483,685 filed Jan. 13, 2000, which claims the benefit of U.S. Provisional Patent Application No. 60/123,995, filed Mar. 11, 1999.

### BACKGROUND OF THE INVENTION

This invention relates to interactive television systems such as interactive television program guide systems, and more particularly, to techniques for scheduling advertisements for presentation to users of these systems.

Cable, satellite, and broadcast television systems provide viewers with a large number of television channels. Viewers have traditionally consulted printed television program schedules to determine the programs being broadcast at a particular time. More recently, interactive electronic television program guides have been developed that allow television program information to be displayed on a viewer's television.

Interactive program guides are typically implemented on set-top boxes. Such program guides allow users to view television program listings in different display formats. For example, a user may instruct the program guide to display a grid of program listings organized in a channel-ordered or a time-ordered list. Users may also search and sort program listings by theme (e.g., movies, sports, etc.) or by title (i.e., alphabetically). A user may obtain additional information for a program by placing a highlight region on a desired program listing and pressing an “info” key. The user may purchase a pay program from the program guide or may set a reminder for a future program by placing the highlight region on a program listing and pressing an “OK” key. Some systems allow the user to select a program for recording by placing the highlight region on a program listing and pressing a “record” key.

Knudson et al. U.S. patent application Ser. No. 09/070,604, filed Apr. 30, 1998, Knudson et al. U.S. patent application Ser. No. 09/034,939, filed Mar. 4, 1998, and Reynolds et al. U.S. patent application Ser. No. 09/352,376, filed Jul. 13, 1999, which are hereby incorporated by reference herein in their entireties, describe systems in which program guides provide advertising. Knudson et al. U.S. patent application Ser. No. 09/070,555, filed Apr. 30, 1998, which is incorporated by reference herein in its entirety, describes systems in which program guides provide advertising in flip and browse program guide modes. The way in which such advertising is presented to users should be scheduled.

It is therefore an object of the present invention to provide an interactive television program guide system in which the presentation of advertisements to users may be scheduled.

### SUMMARY OF THE INVENTION

These and other objects of the invention are accomplished in accordance with the principles of the present invention by providing a system for displaying interactive advertisements on user television equipment. The system may receive orders from customers who desire to have their interactive advertisements displayed to users on user television equipment. The orders may be electronic orders. Such orders may include the customer's advertisement and may include advertisement-related information. The advertisement-related information may be information selected by the customers that indicates how the customer's interactive advertisement is to be displayed.

The customer may provide advertisement-related information from an order entry display screen at the customer's premises, at a television distribution facility, at a main facility, or at another suitable location for data entry. Orders may be transmitted to a scheduling location via a communications path such as an Internet communications path. Advertisement-related information may include advertisement size, screen location, type, form, day part, day, default highlight window position, screen group, time zone preference, priority, etc. The system may determine a price for the order based on the advertisement-related information, the success rate for delivery of the advertisements to the user television equipment, program guide usage, etc.

Advertisement-related information may be assigned to interactive advertisements. The system may schedule how the interactive advertisements are to be displayed based on the assigned interactive-advertisement-related information.

The system may provide a local customization feature, which provides opportunities to locally set or modify a rotation order of a national advertisement schedule, delete certain advertisements from a national schedule, insert local advertisements in available portions of a national schedule, etc.

Interactive advertisements having different formats (e.g., text, video, graphics, sets, etc.) may be assigned to the same or different schedules. Interactive advertisements may be assigned a rotation type (e.g., a session-based type, a screen-group based type, a screen based type, a time-based type, etc.). Interactive advertisements may be stored in a compressed format. The system may predict which interactive advertisements are likely to be displayed next based on the rotation type. Interactive advertisements that are expected to be displayed may be decompressed when currently-displayed interactive advertisements are not needed. Interactive advertisements may be assigned a category to aid in preventing interactive advertisements from being displayed on inappropriate display screens. Interactive advertisements may be assigned a rotation order. A random starting point in the rotation order may be selected for displaying advertisements.

Interactive advertisements may be scheduled to compensate for time zone differences. Interactive advertisements may be assigned to a day part based on a single time zone. If desired, interactive advertisements may be assigned to a day part that corrects for multiple broadcast feeds of television networks due to differences in time zones.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive television program guide system in accordance with the present invention.

FIG. 2 is a flow chart of illustrative steps involved in providing interactive advertisements in accordance with the present invention.

FIG. 3 is a diagram of an illustrative order entry display screen in accordance with the present invention.

FIG. 4 is a flow chart of illustrative steps involved in scheduling of interactive advertisements in accordance with the present invention.

FIG. 5a is a flow chart of illustrative steps involved in dividing a time period into parts for scheduling advertisements in accordance with the present invention.

FIG. 5b is diagram of illustrative pie chart time-part definitions in accordance with the present invention.

FIG. 6a is a diagram of illustrative steps involved in dividing a time period for scheduling different forms of advertisement in accordance with the present invention.

FIG. 6b is diagram of illustrative pie chart time-part definitions for different forms of advertisement in accordance with the present invention.

FIG. 6c is a diagram of an illustrative sequence of display screens displaying advertisements based on the time-part definitions of FIG. 6b in accordance with the present invention.

FIG. 7a is diagram of an illustrative pie chart time-part definition in accordance with the present invention.

FIG. 7b is a diagram of an illustrative sequence of illustrative display screens that display advertisements based on the time-part definitions of FIG. 7a in accordance with the present invention.

FIG. 8a is a flow chart of illustrative steps involved in scheduling advertisements in accordance with the present invention.

FIG. 8b is diagram of illustrative pie chart time-part definitions for different forms of advertisements in accordance with the present invention.

FIG. 8c is a diagram of an illustrative display screen that includes a scheduled set of advertisements in accordance with the present invention.

FIG. 9a is a flow chart of illustrative steps involved in displaying interactive advertisements based on advertisement category in accordance with the present invention.

FIG. 9b is diagram of an illustrative data table and illustrative display screens having categorized interactive advertisements in accordance with the present invention.

FIG. 10a is a flow chart of illustrative steps involved in displaying interactive advertisements based on size, type, screen location, and highlight window information in accordance with the present invention.

FIG. 10b is a diagram of a set of illustrative display screens having advertisements of different size, screen location, type, and default highlight window position in accordance with the present invention.

FIG. 11a is a flow chart of illustrative steps involved in displaying interactive advertisements in a day-part in accordance with the present invention.

FIG. 11b is a diagram of an illustrative data table for interactive advertisements for a morning day-part and an illustrative sequence of illustrative display screens having interactive advertisements in accordance with the present invention.

FIG. 12a is a flow chart of illustrative steps involved in providing a rotation type for interactive advertisements in accordance with the present invention.

FIG. 12b is a diagram of an illustrative data table for interactive advertisements in accordance with the present invention.

FIG. 13a is a flow chart of illustrative steps involved in providing session-based rotation in accordance with the present invention.

FIG. 13b is a diagram of an illustrative sequence of display screens having interactive advertisements in session-based rotation in accordance with the present invention.

FIG. 14a is a flow chart of illustrative steps involved in providing screen-based rotation in accordance with the present invention.

FIG. 14b is a diagram of an illustrative sequence of display screens having interactive advertisements in screen-based rotation in accordance with the present invention.

FIG. 15a is a flow chart of illustrative steps involved in providing screen-group based rotation in accordance with the present invention.

FIG. 15b is a diagram of an illustrative sequence of display screens having interactive advertisements in screen-group based rotation in accordance with the present invention.

FIG. 16a is a flow chart of illustrative steps involved in providing time-based rotation in accordance with the present invention.

FIG. 16b is a diagram of an illustrative sequence of display screens having interactive advertisements in time-based rotation in accordance with the present invention.

FIG. 17a is a flow chart of illustrative steps involved in providing interactive advertisements from storage in accordance with the present invention.

FIG. 17b is a diagram of an illustrative sequence of display screens having interactive advertisements provided from storage in accordance with the present invention.

FIG. 18a is a flow chart of illustrative steps involved in displaying interactive advertisements based on assigned priority in accordance with the present invention.

FIG. 18b is a diagram of an illustrative data table and an illustrative sequence of display screens having interactive advertisements in accordance with the present invention.

FIG. 19 is a diagram of an illustrative data table and an illustrative sequence of display screens having interactive advertisements in accordance with the present invention.

FIG. 20 is a diagram of an illustrative data table, an illustrative data table for a bonus pool of interactive advertisements, and an illustrative sequence of display screens having interactive advertisements in accordance with the present invention.

FIG. 21 is a diagram of an illustrative data table and an illustrative sequence of display screens having interactive advertisements in accordance with the present invention.

FIG. 22 is a diagram of an illustrative data table and an illustrative sequence of display screens having interactive advertisements in accordance with the present invention.

FIG. 23a is a flow chart of illustrative steps involved in scheduling interactive advertisements based on a single time zone in accordance with the present invention.

FIG. 23b is diagram of illustrative display screens having an interactive advertisement scheduled for each display screen based on a single time zone in accordance with the present invention.

FIG. 24a is a flow chart of illustrative steps involved in scheduling interactive advertisements to correct for multiple broadcast feeds in accordance with the present invention.

FIG. 24b is a diagram of illustrative display screens in which interactive advertisement is scheduled for each display screen to correct for multiple broadcast feeds in accordance with the present invention.

FIG. 25 is a diagram of an illustrative local customization display screen in accordance with the present invention.

FIG. 26a is a diagram of an illustrative sequence of display screens for displaying interactive advertisements without local customization in accordance with the present invention.

FIG. 26b is a diagram of an illustrative sequence of display screens for displaying interactive advertisements with local customization in accordance with the present invention.

FIG. 27 is a diagram of an illustrative data table for a national schedule, an illustrative data table for a local schedule, and an illustrative sequence of display screens having interactive advertisements in accordance with the present invention.

FIG. 28 is a diagram of an illustrative data table for interactive advertisements and an illustrative sequence of display screens in accordance with the present invention.

FIG. 29 is a diagram of an illustrative data table for interactive advertisements and an illustrative sequence of display screens in accordance with the present invention.

FIG. 30 is a diagram of an illustrative data table for interactive advertisements, an illustrative data table for local interactive advertisements, and an illustrative sequence of display screens having interactive advertisements in accordance with the present invention.

FIG. 31a is a flow chart of illustrative steps involved in one approach for distributing local advertisements in accordance with the present invention.

FIG. 31b is a flow chart of illustrative steps involved in another approach for distributing local advertisements in accordance with the present invention.

FIG. 32 is a flow chart of illustrative steps involved in providing local customization of interactive advertisements in accordance with the present invention.

FIG. 33a is a flow chart of illustrative steps involved in providing a price for advertisement orders in accordance with the present invention.

FIG. 33b is a diagram of an illustrative order information summary display screen in accordance with the present invention.

FIG. 34 is a diagram of an illustrative display screen having an interactive advertisement and an illustrative display screen that may be displayed when the interactive advertisements is selected in accordance with the present invention.

### DETAILED DESCRIPTION OF THE PREFERRED EMBODIMENTS

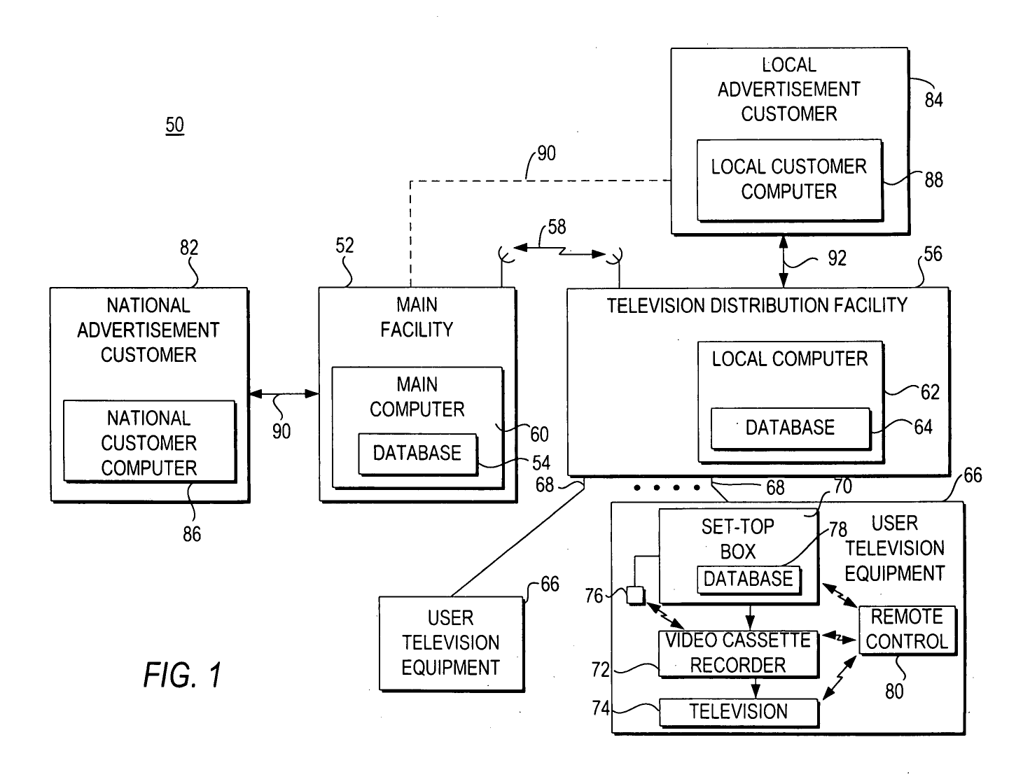

An illustrative program guide system 50 in accordance with the present invention is shown in FIG. 1. Main facility 52 may contain a main computer 60 that contains a database 54 for storing program guide information such as television program guide listings data, pay-per-view ordering information, television program promotional information, etc. Database 54 may also be used for storing advertising information. Information from database 54 may be transmitted to television distribution facility 56 via communications link 58. Link 58 may be a satellite link, a telephone network link, an Internet link, a cable or fiber optic link, a microwave link, a combination of such links, or any other suitable communications path.

Television distribution facility 56 is a facility for distributing television signals to users, such as a cable system headed, a broadcast distribution facility, or a satellite television distribution facility.

The program guide information transmitted by main facility 52 to television distribution facility 56 includes television program listings data such as program times, channels, titles, descriptions, etc. Transmitted program information also includes pay program data such as pricing information for individual programs and subscription channels, time windows for ordering programs and channels, telephone numbers for placing orders that cannot be impulse ordered, etc. The advertising information transmitted by main facility 52 to television distribution facility 56 may include text, graphics, video advertisements, and scheduling information for various products and services. If desired, some of the program guide and advertising information may be provided using data sources at facilities other than main facility 52. For example, data related to pay program order processing (e.g., billing data and the like) may be generated by an order processing and billing system that is separate from main facility 52 and separate from television distribution facility 56. Similarly, advertising information may be generated by an advertising facility that is separate from main facility 52 and television distribution facility 56.

Regardless of its source, advertising information may be maintained on a local computer 62 within television distribution facility 56 if desired. Local computer 62 may be capable of handling text, graphics, and video. Local computer 62 may, for example, be a server.

Television distribution facility 56 distributes program guide and advertising information to the user television equipment 66 of multiple users via communications paths 68. User television equipment 66 may be any suitable equipment or device for providing television to the user that contains sufficient processing capabilities to implement an interactive television program guide. Paths 68 may be cable links, fiber optic links, satellite links, broadcast links, or other suitable link or combination of such links. Any suitable communications scheme may be used to transmit data over paths 68, including in-band transmissions, out-of-band transmissions, digital transmissions, analog transmissions, cable transmissions, satellite transmissions, cable modem transmissions, over-the-air transmissions, multichannel multipoint distribution services (MMDS) transmissions, etc.

If desired, program guide data may be distributed over an out-of-band channel on paths 68 or over an in-band path such as the vertical blanking interval (VBI). Advertising information may be distributed using any of a number of suitable techniques. For example, text and graphics advertisements may be distributed over an out-of-band channel using an out-of-band modulator. Video advertisements may also be distributed in this way, although large quantities of video information may be more efficiently distributed using one or more digital channels or data streams on path 68. Such digital channels or data streams may also be used for distributing text and graphics.

Each user has a receiver, which is typically a set-top box such as set-top box 70, but which may be other suitable television equipment such as an advanced television receiver into which circuitry similar to set-top-box circuitry has been integrated, a personal computer television (PC/TV), or a personal computer (e.g., with a television tuner cord). Program guide data may be distributed to set-top boxes 70 periodically, on-demand, continuously, or in a combination thereof. Television distribution facility 70 may also poll set-top boxes 70 periodically for certain information (e.g., pay program account information or information regarding programs that have been purchased and viewed using locally-generated authorization techniques). Main facility 52 preferably contains a processor to handle information distribution tasks. For example, main computer 60 within main facility 52 may handle such tasks. Each set-top box 70 preferably contains a processor to handle tasks associated with implementing a program guide application or other interactive television application such as a home shopping application, a web browser application, a home banking application, or video-on-demand application, a chat application, an email application, etc., on the set-top box 70. For clarity, the present invention will be described primarily in the context of interactive television program guide applications, but the invention also applies to other interactive television applications. Television distribution facility 56 may contain a processor for handling tasks associated with the distribution of program guide and advertising information. For example, television distribution facility 56 may contain local computer 62 for handling such tasks.

Each set-top box 70 is typically connected to an optional videocassette recorder 72 so that selected television programs may be recorded. Each videocassette recorder 72 is connected to a television 74 or other viewing device. To record a program, set-top box 70 tunes to a particular channel and sends control signals to videocassette recorder 72 (e.g., using infrared transmitter 76) that direct videocassette recorder 72 to start and stop recording at the appropriate times. The use of a videocassette recorder in user television equipment 66 is illustrative only. If desired, any suitable recording device may be used, including digital video recorders, a digital video disks (DVD) player with recording capabilities, hard disk, etc.

During use of the interactive television program guide implemented on set-top box 70, television program listings may be displayed on television 74 or other suitable monitor. Each set-top box 70, videocassette recorder 72, and television 74 may be controlled by one or more remote controls 80 or any other suitable user input interface such as a wireless keyboard, mouse, trackball, dedicated set of keys, touch screen display remote, etc.

Communications paths 68 preferably have sufficient bandwidth to allow television distribution facility 56 to distribute scheduled television programming, pay programming, advertising and other promotional videos, and other video information to set-top boxes 70 in addition to non-video program guide and advertising data. Multiple television and audio channels (analog, digital, or both analog and digital) may be provided to set-top boxes 70 via communications paths 68. If desired, program listings and advertising information may be distributed by one or more distribution facilities that are similar to but separate from television distribution facility 56 using communications paths that are separate from communications paths 68.

Certain functions such as pay program purchasing may require set-top boxes 70 to transmit data to television distribution facility 56 over communications paths 68. If desired, such data may be transmitted over telephone lines or other separate communications paths. If functions such as these are provided using facilities separate from television distribution facility 56, some of the communications involving set-top boxes 70 may be made directly with the separate facilities.

Users may interactively order additional information, products, or services. Such orders may be satisfied by fulfillment facilities (not shown). If desired, orders may be transmitted directly to fulfillment facilities via links which may be telephone links, the Internet, or other suitable communications links. Orders may also be transmitted to television distribution facility 56 via links 68, where the billing system of the television distribution facility may be used. After the television distribution facility 56 has processed the user's order, television distribution facility 56 may transmit the order to a fulfillment facility.

A number of suitable techniques may be used to distribute videos related to advertising. For example, if each path 68 includes a number of traditional analog television channels, one or more of these channels may be used to support a number of digital channels (or data streams). The bandwidth of each analog channel that is used to support digital channels may support ten or more of such digital channels. If desired, videos may be provided from local computer 62 in a continuously looped arrangement on these digital channels. Information provided to set-top box 70 may then be used to determine which digital channels to tune to when it is time to display a desired video. If desired, videos may be provided on demand. With this approach, set-top box 70 and local computer 62 may negotiate to determine a channel on which to provide the desired video. Videos that originate from main facility 52 or a separate facility are preferably distributed to user television equipment 66 using these or other suitable techniques.

Graphics information for advertisements may be downloaded periodically (e.g., once per day) to set-top boxes 70 and stored locally. For example, set-top box 70 may contain database 78 for storing graphics information. The graphics information may be accessed locally when needed by the program guide implemented on set-top box 70. If desired, graphics information may be provided in a continuously-looped arrangement on one or more digital channels on paths 68. With such a continuously-looped arrangement, a map indicating the location of the latest graphics information may be downloaded periodically to set-top boxes 70 (e.g., once per day). This allows the content on the digital channels to be updated. The program guides on set-top boxes 70 may use the map to locate desired graphics information on the digital channels. Another approach involves using a server such as local computer 62 to provide the graphics information after a set-top box 70 and that server have negotiated to set up a download operation. A bitmap or other suitable set of graphics information may then be downloaded from the server to the set-top box. If desired, the server may download instructions informing the set-top box where the desired graphics information can be located on a particular digital channel. The graphics information can be updated periodically if the server that is responsible for downloading the instructions for informing the set-top box of the location of the graphics information is also updated periodically.

Text information for advertisements may be provided to set-top boxes 70 using the same paths that are used for distributing program guide data. For example, advertising data from database 54 may be provided to set-top boxes 70 using link 58, television distribution facility 56, and paths 68. The text information may be stored locally in set-top boxes 70 and updated periodically (e.g., once per day), on-demand, continuously, or in a combination thereof.

Text information, graphics information, and videos for advertisements may also be distributed using a combination of these techniques or any other suitable technique.

If desired, an interactive television program guide may be implemented using a data-relay architecture. In such an architecture, television distribution facility 56 may serve as a data relay site and user television equipment 66 may be a data destination site. For example, television distribution facility 56 may continuously or periodically distribute information as the information is received. In a data-relay architecture, a program guide implemented on user television equipment 66 may use a database (e.g., database 78) for storing program guide and advertising information at user television equipment 66. Program guide information may include program listings and program attributes. Advertising information may include interactive advertisements and scheduling information. Television distribution facility 56 may also poll set-top boxes 70 periodically for certain information (e.g., pay program account information or information regarding programs that have been purchased and viewed using locally-generated authorization techniques).

The features of the present invention may be implemented in a client-server arrangement or in a combination client-server and data-relay arrangement.

For clarity, the present invention is sometimes described primarily in the context of program guides that are implemented on user television equipment 66 rather than in the context of program guides that are implemented partially on local computer 62 and partially on user television equipment 66 or a more fully server-based architecture.

Interactive advertisement orders may be placed by customers such as national advertisement customer 82 and local advertisement customer 84. Orders for advertisements may be placed using computer systems at main facility 52 and at locations external to main facility 52 such as at national advertisement customer 82 or at local advertisement customer 84. Computer systems at advertisement customer locations such as national customer computer 86 and local customer computer 88 may store interactive advertisements, may include executable code for ordering the scheduling and display of interactive advertisements, and may include executable programming in combination with communication equipment for transmitting orders, advertising information, or advertisements to main facility 52 via path 90. If desired, local customer 84 may also use path 92 to transmit orders, advertising information, or advertisements directly to television distribution facility 56. Path 90 may provide Internet communications paths between main facility 52 and advertisement customers 82 and 84. Path 92 may be used to support Internet communications between television distribution facility 56 and local advertisement customer 84. If desired, paths 90 and 92 may also be any other suitable communications path capable of handling such advertising related data.

After the initial reception of advertisements and advertisement-related information from advertisement customers 82 or 84, main facility 54 may transmit advertisements and such related information to television distribution facility 56 for further distribution. Advertisements and related information may then be stored at database 64 and may be distributed continuously, periodically, or on-demand to user television equipment 66. A combination of continuous, periodic, or on-demand distribution techniques may also be used. Database 78 at user television equipment 66 may also store advertisements and advertisement-related information for presenting advertisements to users. Main facility 52, television distribution facility 56, or user television equipment 66 may be used individually or in combination to schedule the presentation of advertisements. Interactive advertisements are typically digital interactive advertisements. For convenience, interactive advertisements are sometimes simply referred to as advertisements.

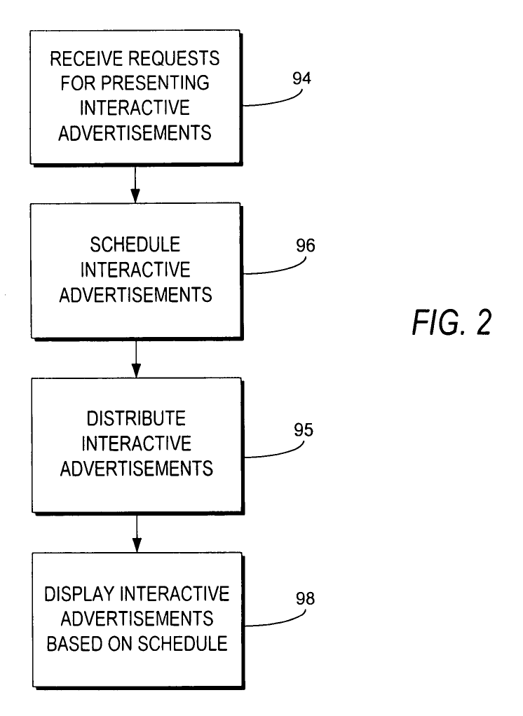

Illustrative steps involved in using an interactive television system such as interactive television program guide system 50 of FIG. 1 to present interactive advertisements to users based on a schedule are shown in FIG. 2. Initially, requests for presenting interactive advertisements are received from customers at step 94. At step 96, interactive advertisements may be scheduled for presentation based on advertising-related information (discussed below). Interactive advertisements may then be distributed to systems for presentation at step 95. At step 98, the program guide may display scheduled interactive advertisements to program guide system users.

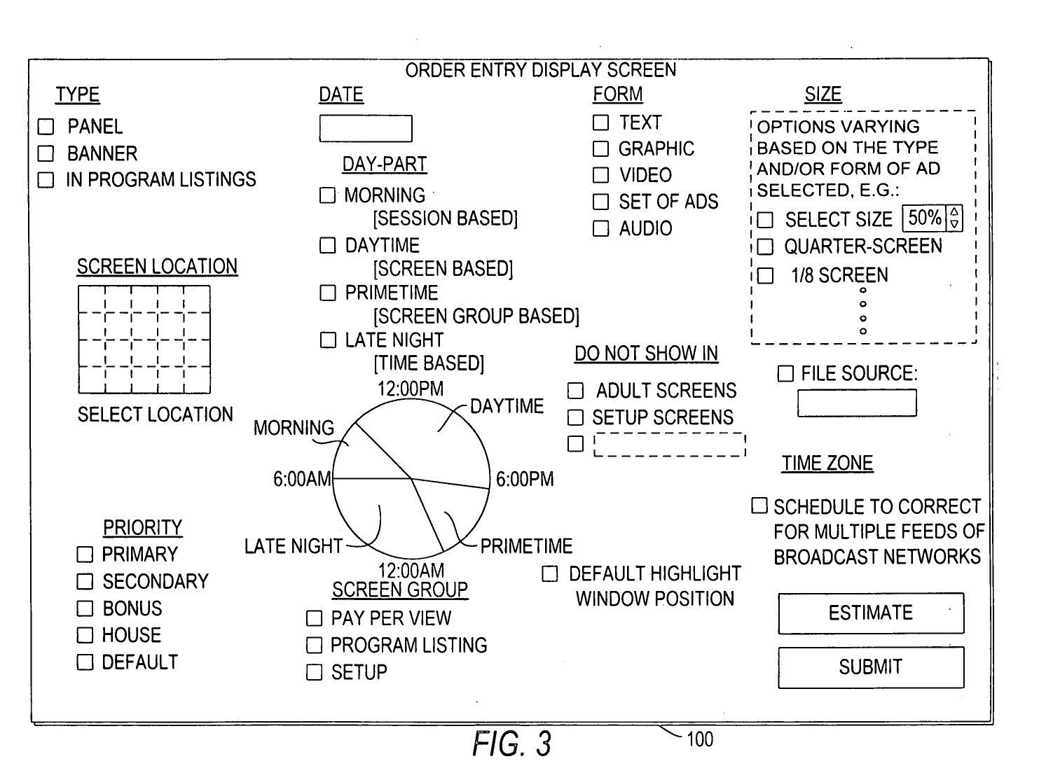

The advertising-related information may include information selected by advertisement customers such as advertisement customers 82 and 84 of FIG. 1 in ordering the presentation of advertisements. Electronic orders for certain interactive advertisements that a customer desires to have displayed to users may be made from illustrative order entry display screen 100 of FIG. 3. Order entry display screen 100 includes examples of advertising-related information that may be selected by advertisement customers in ordering advertisements to be scheduled for display. Order display screen 100 provides an opportunity to select the advertisement type, form, size, screen location, priority, screen group, day part, file source, or date of display. Order entry display screen 100 may also provide an opportunity to select an option that excludes an advertisement from being displayed in certain screen groups, select an option that corrects for multiple time zone feeds in scheduling the customer's advertisement, select an option to receive an estimate for an order, select an option to submit an advertisement order with the advertising-related information that has been selected, etc. A customer may be provided direct access to order entry display screen 100. If desired, a customer may be provided access indirectly (e.g., a computer operator may orally receive a customer's order for entry with order entry display screen 100).

Order entry display screen 100 may include a pie chart for illustrating the duration and time for each day-part. How the pie chart is divided may vary based on which date the advertisement is to be displayed.

Electronic orders for advertisements may be transmitted to an order reception site such as main facility 52 of FIG. 1 or television distribution facility 56 of FIG. 1. Any suitable technique may be used for making the transmissions, such as using an Internet connection, point-to-point communications, floppy disk delivery, etc.

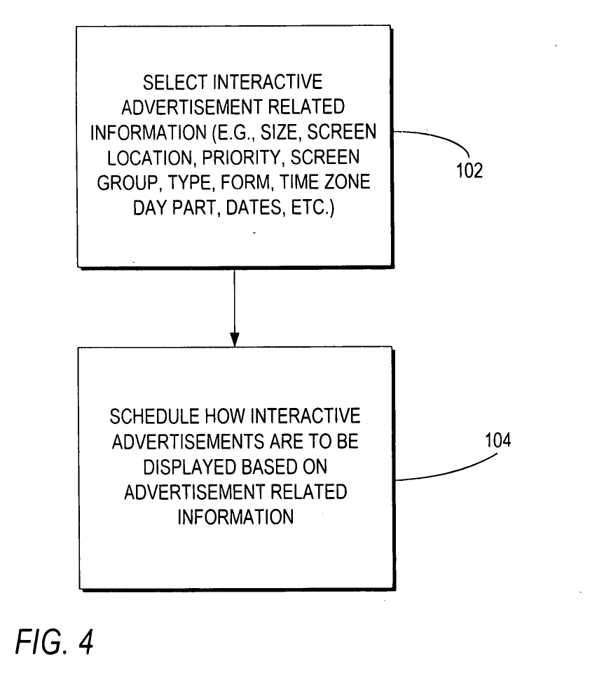

Illustrative steps involved in scheduling interactive advertisements for presentation to users in an interactive television system such as interactive television program guide system 50 of FIG. 1 are shown in FIG. 4. At step 102, an advertisement customer may select interactive advertisement related information such as type, form, size, screen location, priority, screen group, time zone, day part, etc. At step 104, the program guide may schedule how interactive advertisements are to be displayed on user television equipment 66 based on the selected information. The selected information may be in an electronic advertisement order. Scheduling how interactive advertisement are to be displayed may involve assigning advertisement-related information to an advertisement. Advertisement-related information may include type, form, size, screen location, priority, screen group, time zone, day part, dates, etc. These attributes may be selected in an electronic order, if desired.

Advertisements may be scheduled based on their assigned screen group. Display screens that are related in content or format may be grouped in screen groups. An assigned screen group may limit the display of an advertisement to screens in the assigned screen group.

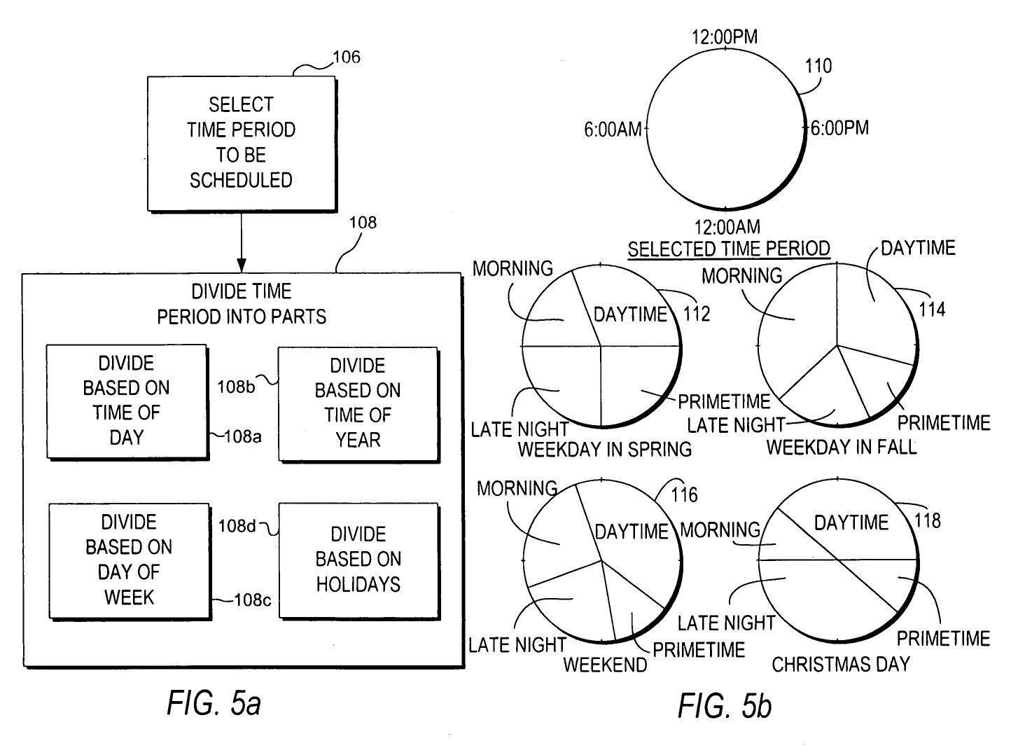

Illustrative steps involved in providing different time parts for advertisements in an interactive television system such as interactive television program guide system 50 of FIG. 1 are shown in FIG. 5a. At step 106, a time period may be selected for presenting interactive advertisements. At step 108, the time period may be divided into parts (i.e., time parts). For example, the time and duration of the divided parts may be based on the time of day (step 108a), the time of year (step 108b), the day of week (step 108c), or the holidays in a year (step 108d). Typically, the time period for presenting advertisements is selected and divided at the main facility (e.g., main facility 52 of FIG. 1).

For convenience, the present invention is discussed in the context of a time period for presenting advertisements that is a day, so that the time parts may be referred to as day parts.

Pie chart 110 of FIG. 5b illustrates how a selected time period may be day-keyed to the time of day. Pie charts 112, 114, 116, and 118 illustrate how days may be divided into different day parts (e.g., morning, day time, prime time, and late night) based on the time of day (e.g., step 108a of FIG. 5a), the time of year (step 108b of FIG. 5a), the day of week (step 108c of FIG. 5a), and the holidays in a year (steps 108c of FIG. 5a). The day parts for pie chart 112, for example, show how a day may be divided based on the time of year (e.g., spring). The day parts for pie chart 114 have been divided based on the time of year and the day of week (e.g., a weekday in Fall). The day parts for pie charts 116 and 118 may be different from each other and from pie charts 112 and 114 because pie charts 116 and 118 may be divided based on the day of week (e.g., weekend) and based on a holiday (e.g., Christmas day), respectively. A customer may select a day part (for example, by selecting a day part from order entry display screen 100 of FIG. 2) to have the customer's advertisement assigned to the selected day part. The advertisement may then be displayed based on the assigned day part (e.g., display the advertisement during the assigned day part). The differing day parts allow advertisements to be priced in proportion to expected user activity during each day part.

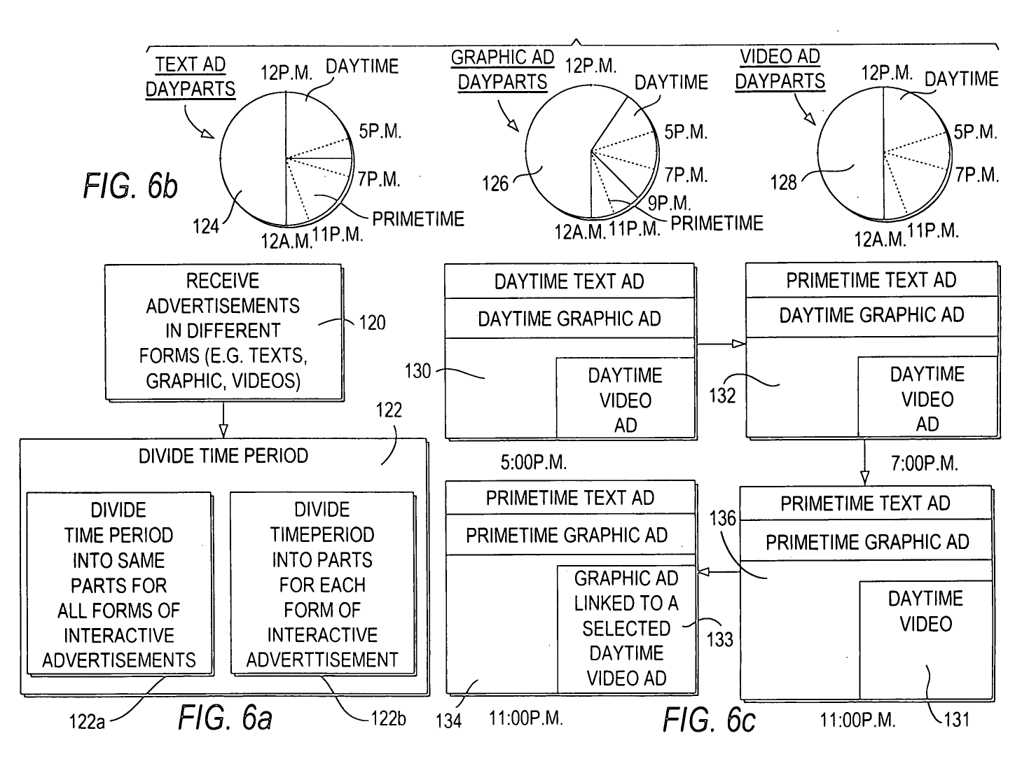

Illustrative steps involved in providing time parts for different forms of interactive advertisements for an interactive television system such as interactive television program guide system 50 of FIG. 1 are shown in FIG. 6a. At step 120, interactive advertisements that have different forms (e.g., text, graphic, video, sets, etc.) may be received for distribution to user television equipment (e.g., user television equipment 66 of FIG. 1). At step 122, time parts may be provided by dividing a time period into parts. The time period may be divided in time parts that are the same for all forms of advertisements (step 122a), that are different for each form of advertisements (step 122b), or that are a combination of the two.

For example, pie charts 124, 126, and 128 of FIG. 6b show day parts having different durations for text, graphic, and video format advertisements. Display screens 130, 132, 134, and 136 of FIG. 6c have interactive advertisements with different forms based on the day parts in pie charts 124, 126, and 128 of FIG. 6b. At 5:00 PM, display screen 130 may be displayed which includes text, graphic, and video advertisements that are scheduled for a day time day part as identified in pie charts 124, 126, and 128 of FIG. 6b.

Pie chart 124 shows that prime time text advertisements are scheduled for 6:00 PM to 12:00 AM. Accordingly, at 7:00 PM, display screen 132 may include a prime time text advertisement with day time graphic and video advertisements.

Pie chart 126 shows that prime time graphic advertisements are scheduled for 9:00 PM to 12:00 AM. Accordingly, at 11:00 PM, display screen 136 may include a prime time graphic advertisement along with a prime time text advertisement and a day time video advertisement.

An interactive advertisement in one form may be linked to an interactive advertisement of a different form. For example, display screen 136 of FIG. 6c may include day time video advertisement 131 that was scheduled for display at 11:00 PM according to pie chart 128 of FIG. 6b. Day time video advertisement 131 may be linked to an advertisement of a different form such as a graphic advertisement 133 of display screen 134. When a user selects day time video advertisement 131, graphic advertisement 133 may be displayed in response.

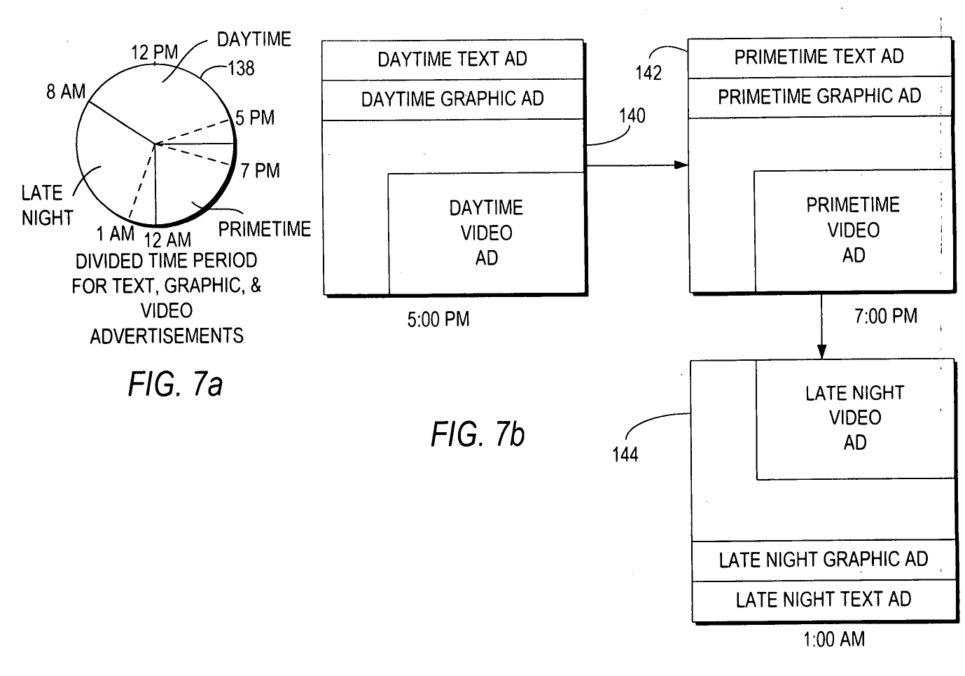

Different forms of interactive advertisements may have the same day part divisions. For example, pie chart 138 of FIG. 7a shows that text, graphic, and video advertisements may have the same day part divisions (day time from 8:00 AM to 12:00 PM, prime time from 6:00 PM to 12:00 AM, and late night from 12:00 AM to 8:00 AM). Display screens 140, 142, and 144 of FIG. 7b include interactive advertisements that are scheduled at 5:00 PM, 7:00 PM, and 1:00 AM respectively, according to pie chart 138 of FIG. 7a.

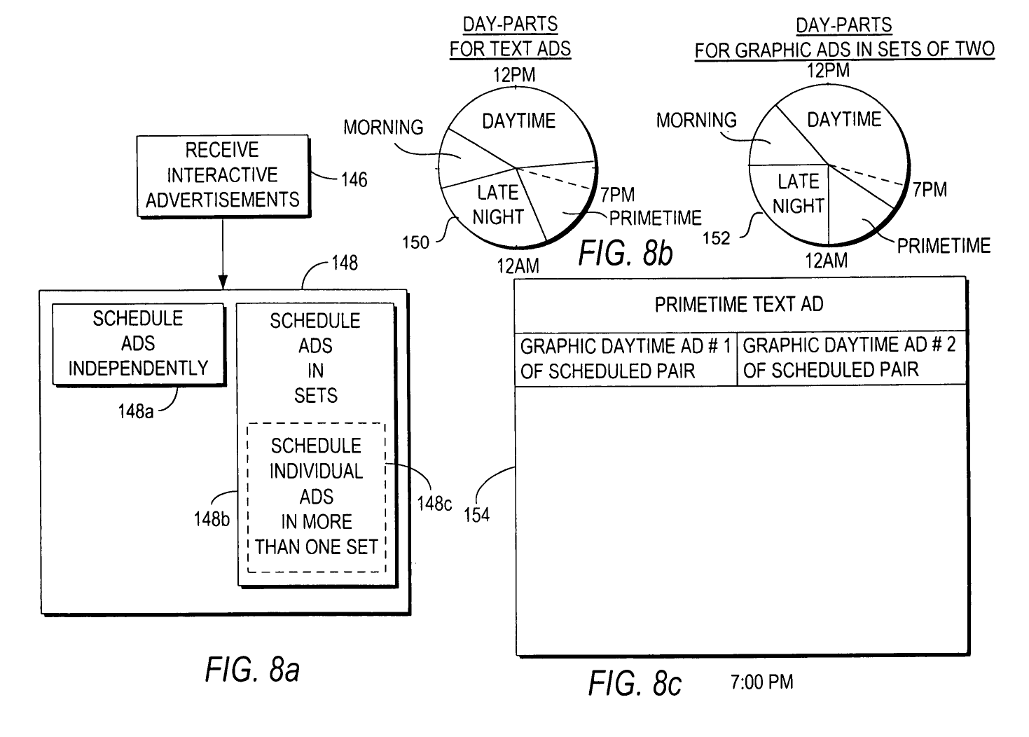

Illustrative steps involved in scheduling interactive advertisements for an interactive television system such as interactive television program guide system 50 of FIG. 1 are shown in FIG. 8a. At step 146, interactive advertisements (e.g., text, graphic, or video advertisements) may be received for distribution to user television equipment (e.g., user television equipment 66 of FIG. 1). At step 148, advertisements may be scheduled independently (step 148a), in sets (step 148b), or in a combination thereof. An individual interactive advertisement may be scheduled in more than one set (step 148c).

For example, as shown in pie charts 150 and 152 of FIG. 8b, text advertisements and graphic advertisements may be scheduled independently. Display screen 154 of FIG. 8c may be displayed based on the schedules provided in pie charts 150 and 152 of FIG. 8b. When display screen 154 is displayed at 7:00 PM, the application may display a text advertisement for a prime time day part and a set of graphic advertisements for a day time day part as scheduled in day part pie chart 152. For convenience in discussing the different aspects of the present invention, a reference to an interactive advertisement or advertisement is a reference primarily to an individual interactive advertisement or an individual set of interactive advertisements.

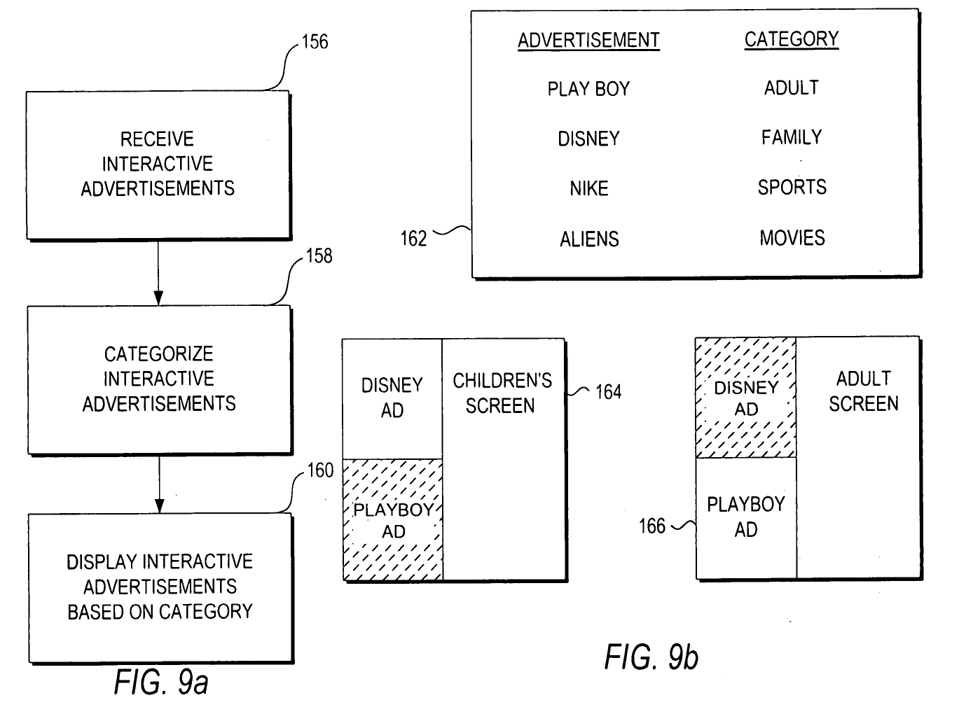

Illustrative steps involved in displaying interactive advertisements based on category for an interactive television system such as interactive television program guide system 50 of FIG. 1 are shown in FIG. 9a. At step 156, interactive advertisements may be received for distribution to user television equipment (e.g., user television equipment 66 of FIG. 1). At step 158, interactive advertisements may be categorized in categories (e.g., adult, family, etc.). At step 160, interactive advertisements may be displayed based on the categories.

For example, as shown in data table 162 of FIG. 9b, an advertisement for Playboy may be categorized to be an adult advertisement, and an advertisement for Disney may be categorized to be a family advertisement. Advertisements may be categorized based on advertisement content or based on the intended audience for advertisements. Assigned categories may aid in preventing advertisement from being displayed in inappropriate display screens.

The category may be employed as a system flag for controlling in which display screen an advertisement may be displayed. For example, the adult categorized Playboy advertisement may not be displayed in a children's display screen 164, and the family categorized Disney advertisement may not be displayed in an adult display screen 166.

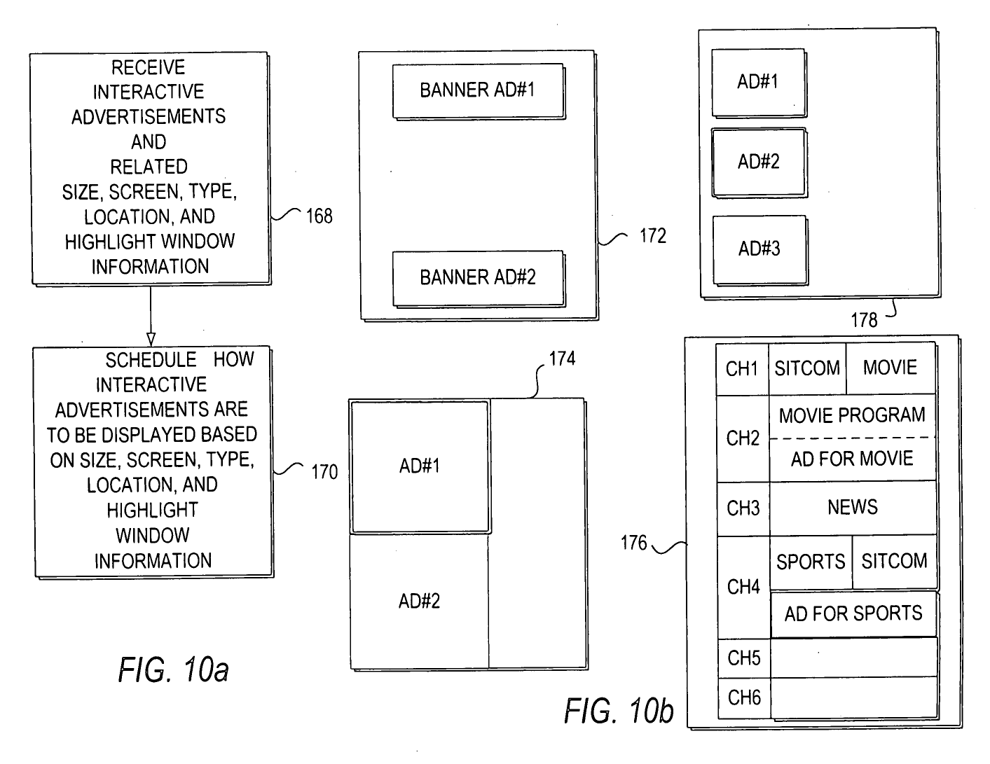

Illustrative steps involved in displaying interactive advertisements based on size, type, screen location, and highlight window advertisement information in an interactive television system such as interactive television program guide system 50 of FIG. 1, are shown in FIG. 10a. At step 168, interactive advertisements that are to be displayed to uses may be received with advertisement-related size, type, screen location, and highlight window information. At step 170, the way in which the interactive advertisements are to be displayed may be scheduled based on the received advertisement-related size, type, screen location, and highlight window information.

For example, an advertisement may be assigned a size and displayed in an appropriate screen based on the size. There may be more than one size available for the advertisement. The size may indicate how much space the advertisement is to occupy. An advertisement may be displayed in screens that have sufficient space to include the advertisement at the assigned size (e.g., sufficient space to display the advertisement without conflict with other advertisements). The interactive television system or program guide system may have suitable hardware and software to vary the size of an advertisement as needed.

Typically, to select an interactive advertisement, a user may be required to navigate a highlight window on an interactive advertisement of interest for selection. An advertisement customer may request to have the initial or default starting position of a highlight window in a display screen to be on that customer's advertisement. An advertisement may be assigned a default highlight window due to a customer request or due to system requirements. Advertisements may be displayed based on which advertisements have been assigned a default highlight window. If desired, each display screen may only have one default highlight window for advertisements.

Type information may indicate that an advertisement may have been assigned an advertisement type (e.g., panel type, banner type, program listings type, etc.). In general, type may indicate the shape of an advertisement. How advertisements are displayed may be scheduled based on their assigned advertisement type.

Screen location information may indicate that an advertisement may have been assigned one of various screen locations. The way in which advertisements are displayed may be based on their assigned screen locations. Advertisement-related form information may indicate the form of an interactive advertisement. Scheduling how an interactive advertisement may be displayed may be based on the form of the advertisement.

Illustrative display screens 172, 174, 176, and 178 of FIG. 10b may be provided based on the illustrative steps of FIG. 10a. Display screens 172 (banner), 174 (panel), and 176 (in program listings) are examples of display screens having advertisements that may have been scheduled based on advertisement type. Display screens 174, 176, and 178 also illustrate that a display screen may include a highlight window for selecting an advertisement and that the default position of a highlight window in a display screen may differ based on the highlight window information. Display screens 174 and 178 further illustrate that advertisements may be scheduled to have differing screen locations or sizes. The size, type, screen location, and highlight window information may have been selected earlier from an order entry display screen (e.g., order entry display screen 100 of FIG. 3).

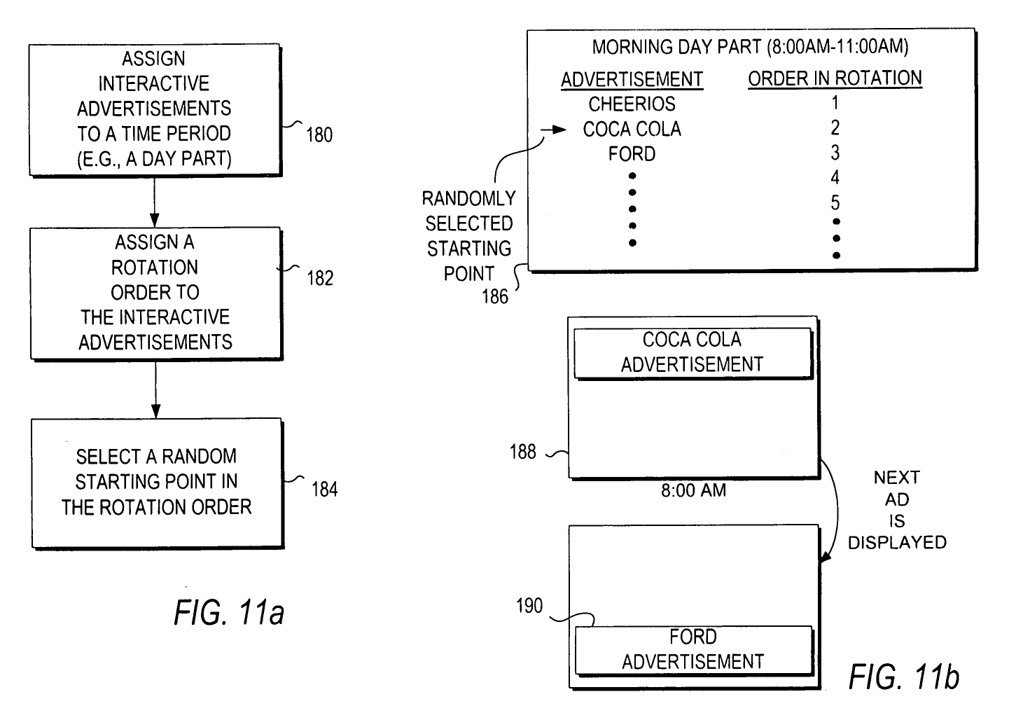

Illustrative steps involved in scheduling to present a group of interactive advertisements in an interactive television program guide system such as interactive television program guide system 50 of FIG. 1 are shown in FIG. 11a. At step 180, interactive advertisements may be assigned to a time period (e.g., a day part). At step 182, a rotation order may be assigned to the interactive advertisements. At step 184, a random starting point in the rotation order may be selected as the starting point for displaying advertisements. A random starting point may be selected for each user television equipment (e.g., user television equipment 66 of FIG. 1) so that an aggregate bias (e.g., a system-wide bias) in favor of displaying one advertisement over another is minimized.

For example, as shown in data table 186 of FIG. 11b, advertisements for Cheerios, Coca Cola, and Ford may be scheduled for a morning day part (8:00-11:00 AM) and may be assigned a rotation order. The advertisement for Coca Cola may have been selected for the random starting point for displaying advertisements in the rotation order.

The Coca Cola, Cheerios, and Ford advertisements may be displayed based on the information in data table 186. For example, when display screen 188 is invoked at 8:00 AM (the beginning of the assigned day part), the advertisement for Coca Cola that had been selected for the random starting point may be displayed. When the next advertisement is invoked, the Ford advertisement 190, the next advertisement in the rotation order may be displayed.

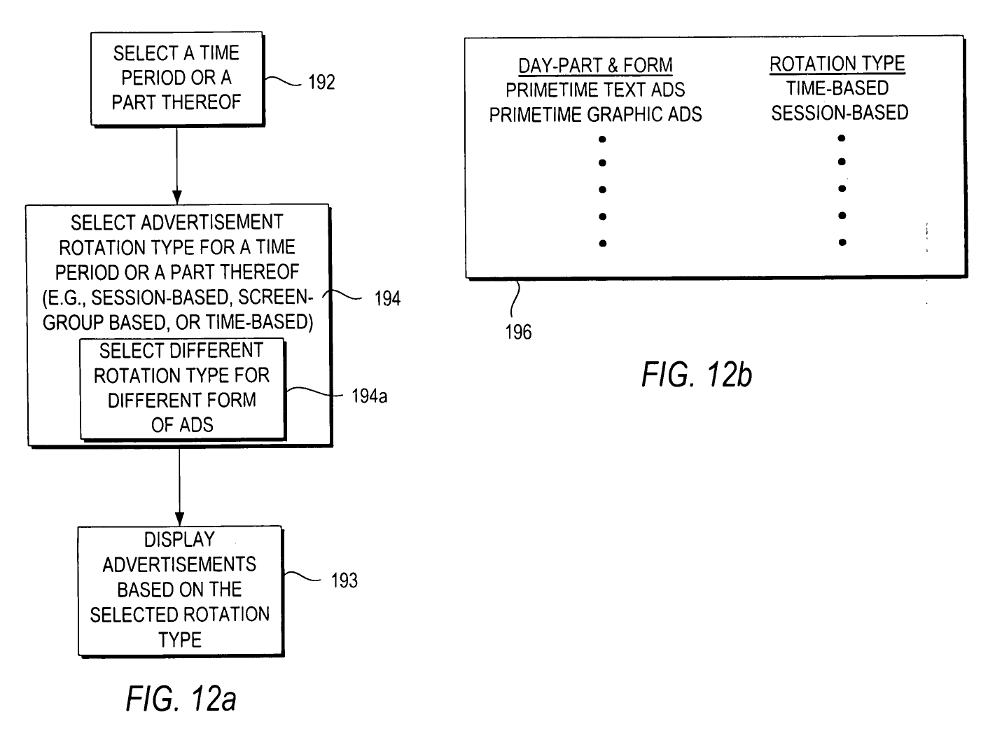

Illustrative steps involved in providing advertisement rotation in an interactive television system such as interactive television program guide system 50 of FIG. 1 are shown in FIG. 12a. At step 192, a time period or time part may be selected for presenting interactive advertisements. At step 194, an advertisement rotation type (e.g., session-based, screen-based, screen-group based, or time-based rotation) may be selected for the time period or time part. Different rotation types may be selected for different forms of advertisement (step 194a). For example, as shown in data table 196 of FIG. 12b, prime time text advertisements may use a time-based rotation while prime time graphic advertisements may use a session-based rotation. At step 193, advertisement may be displayed during the selected time period based on the selected rotation type.

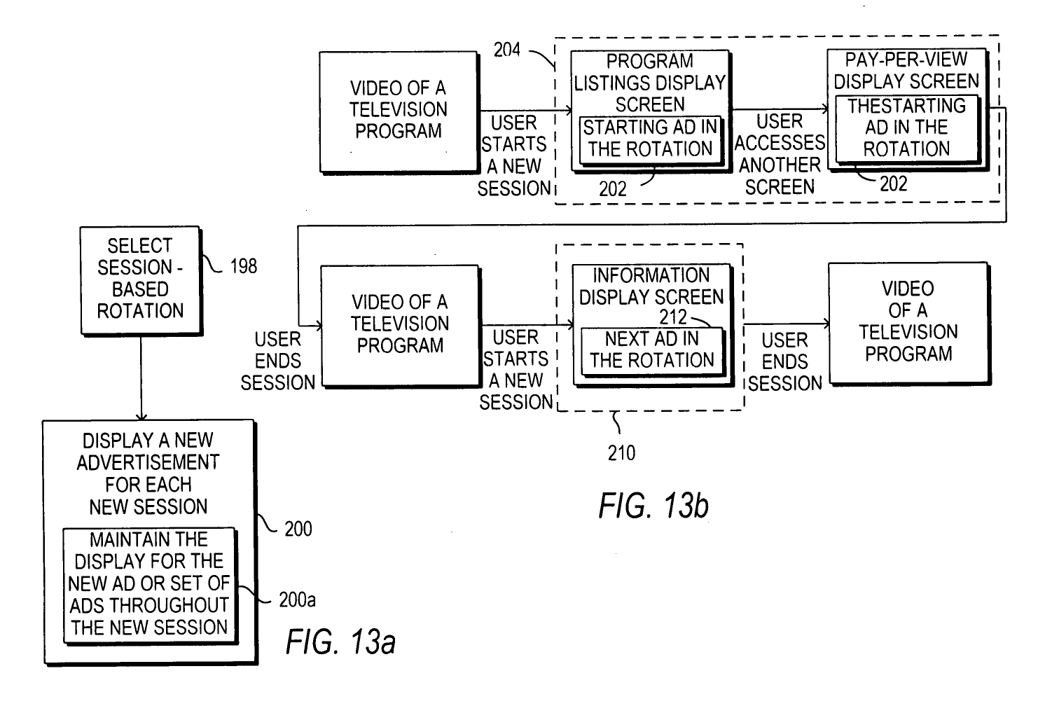

For example, a session-based rotation may have been selected as the rotation type. Illustrative steps involved in providing a session-based rotation are shown in FIG. 13a. A session is a period dedicated to accessing display screens. For example, a session begins when a user accesses a display screen while watching television and ends when the user returns to watching television. At step 198, a session-based rotation may be selected for controlling the rotation of advertisements. At step 200, when a session-based rotation is selected, the program guide may display a new advertisement for every session. The program guide may maintain the display for the same new advertisement during each session (step 200a) despite screen changes that may have been made during the session.

For example, as shown in FIG. 13b, an advertisement 202 that may have been the starting advertisement in the rotation is displayed during the first session 204. When the user ends the first session 204 and commences a new session 210, the next advertisement 212 in the rotation is displayed.

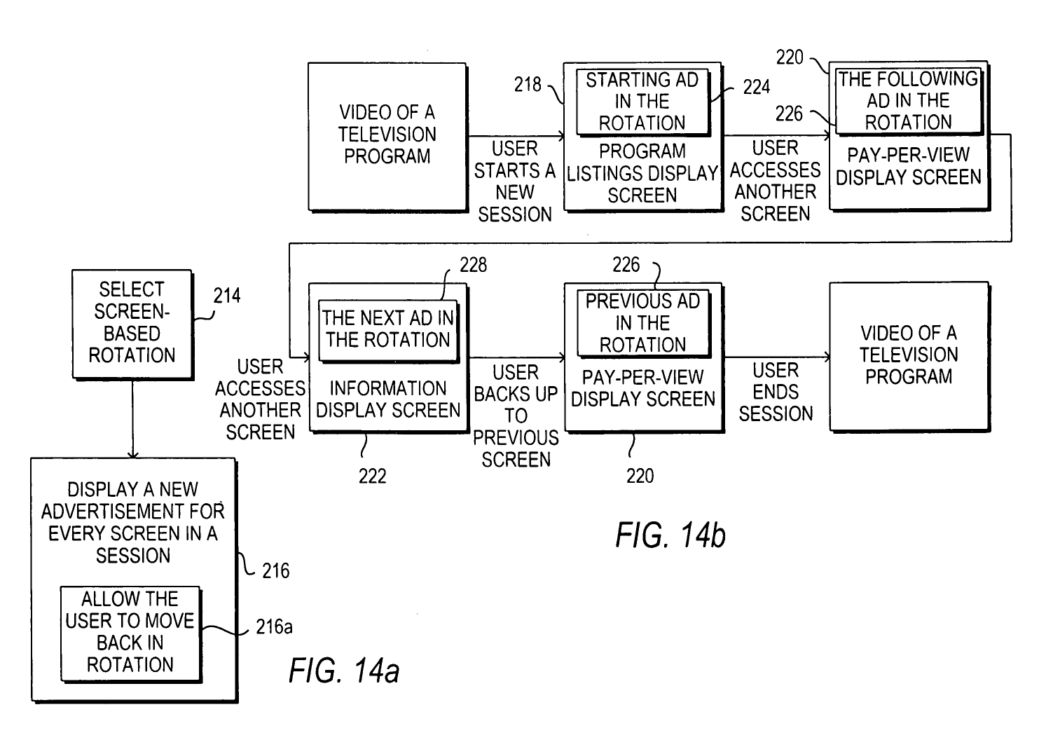

Illustrative steps involved in providing screen-based rotation of interactive advertisements for an interactive television system such as interactive television program guide system 50 of FIG. 1 are shown in FIG. 14a. At step 214, a screen-based rotation may be selected for controlling the rotation of advertisements. At step 216, in response to selecting a screen-based rotation, the program guide may display a new advertisement for every display screen in a session. At step 216a, when the user moves back to previous display screens, advertisements which were previously displayed may be displayed again in the same display screens. Thus, the interactive television application or program guide may allow the user to move back through previous display screens to view previously displayed advertisements.

For example, as shown in FIG. 14b, every time a user access a new program guide display screen 218, 220, and 222, the next advertisement in the rotation (e.g., advertisements 224, 226, and 228) may be displayed. A user may take actions from display screen 222 to move to the previous display screen, display screen 220. When the user moves back, the program guide may again display the same advertisement 226 in display screen 220.

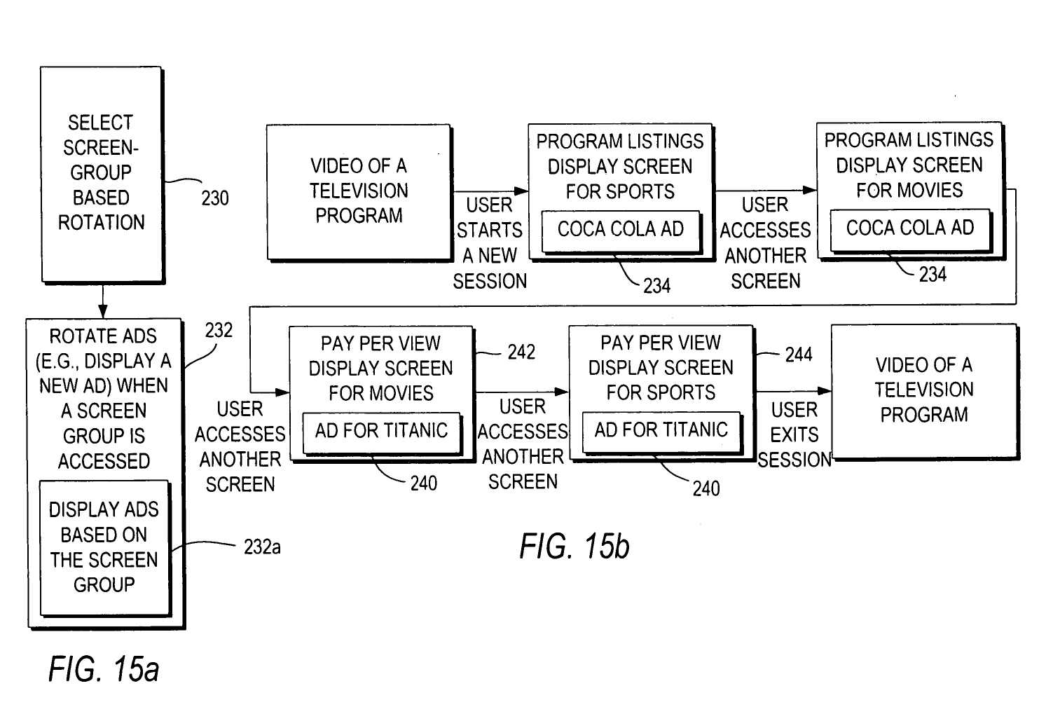

Illustrative steps involved in providing screen-group based rotation of interactive advertisements for an interactive television system such as interactive television program guide system 50 of FIG. 1 are shown in FIG. 15a. At step 230, a screen-group based rotation may be selected for controlling the rotation of advertisements. In screen-group based rotations, display screens may be grouped with related display screens (e.g., listing screens, pay-per-view screens, setup screens, etc.) At step 232, the program guide may rotate advertisements (e.g., display a new advertisement) when a new screen group is accessed. At step 232a, which advertisement is displayed may be determined based on which screen group is being accessed.

For example, as shown in FIG. 15b, a new advertisement, (Coca Cola advertisement 234) is displayed when a program listings display screen for sports in a program listings screen group is accessed. Advertisements are not rotated until a display screen in another screen group is accessed. An advertisement for Titanic 240 (a new advertisement) is displayed when the user accesses another screen group by accessing movie pay-per-view display screen 242. The advertisement for Titanic 240 continues to be displayed when another display screen, sports pay-per-view display screen 244, which is in the same screen group as movie pay-per-view display screen 242, is accessed. The advertisement for Titanic 240 may have been displayed in the movie pay-per-view display screen 242 because of the screen group for the movie pay-per-view display screen 242.

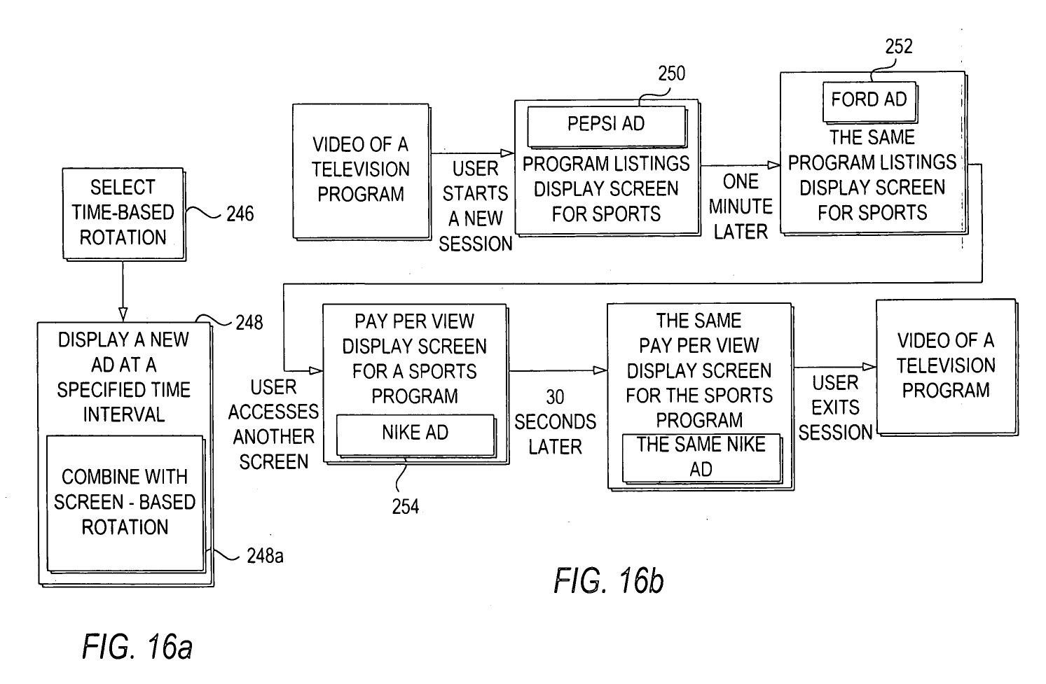

Illustrative steps involved in providing a time-based rotation for interactive advertisements in an interactive television system such as interactive television program guide system 50 of FIG. 1 are shown in FIG. 16a. At step 246, a time-based rotation may be selected for controlling the rotation of advertisements. At step 248, in response to selecting the time-based rotation, the program guide may display a new advertisement when a predetermined time period has expired. At step 248a, if desired, a new advertisement may be displayed when the predetermined period of time has expired or, if desired, when another display screen is accessed before the time period expires.

For example, as shown in FIG. 16b, Pepsi advertisement 250 may be displayed when a user starts a new session. The Ford advertisement 252, which is the next advertisement in the rotation, may be displayed a predetermined period (e.g., one minute) after Pepsi advertisement 250 has been displayed. If desired, the next advertisement, Nike advertisement 254, may be displayed when a user accesses another display screen in less than the predetermined period of time (e.g., in less than one minute after Ford advertisement 252 has been displayed).

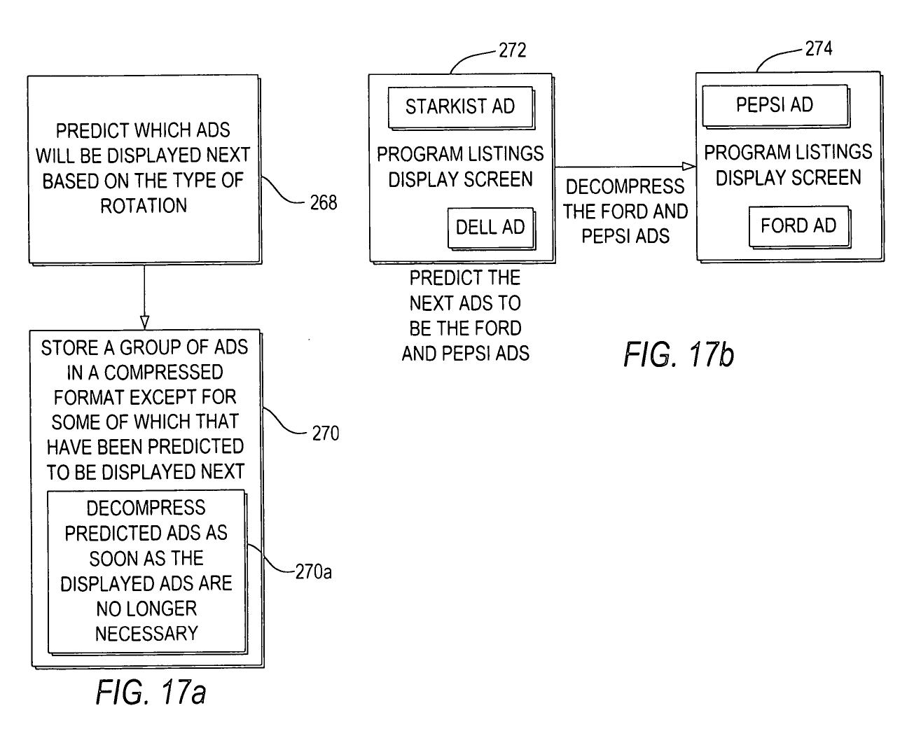

The storage space necessary for storing interactive advertisements may be reduced by displaying advertisements based on a predetermined rotation type. Illustrative steps involved in storing advertisements based on a rotation type for an interactive television system such as interactive television program guide system 50 of FIG. 1 are shown in FIG. 17a. At step 268, the program guide or the interactive application may predict which advertisements are to be displayed next based on the rotation type for the advertisements. At step 270, the program guide or other application may store a group of interactive advertisements in compressed format and may decompress advertisements that it has been predicted will be displayed next. If desired, the advertisements to be displayed next may be decompressed as soon as displayed advertisements are no longer needed (270a).

For example, as shown in FIG. 17b, the program guide may predict that the advertisements that are likely to be displayed next are the advertisements for Ford and Pepsi. The program guide may then decompress the Ford and Pepsi advertisements for display. The program guide may decompress the Ford and Pepsi advertisements after the current advertisements (the Starkist and Dell advertisements contained in display screen 272) are no longer needed. After being decompressed, the Pepsi and Ford advertisements may be displayed in the next display screen 274.

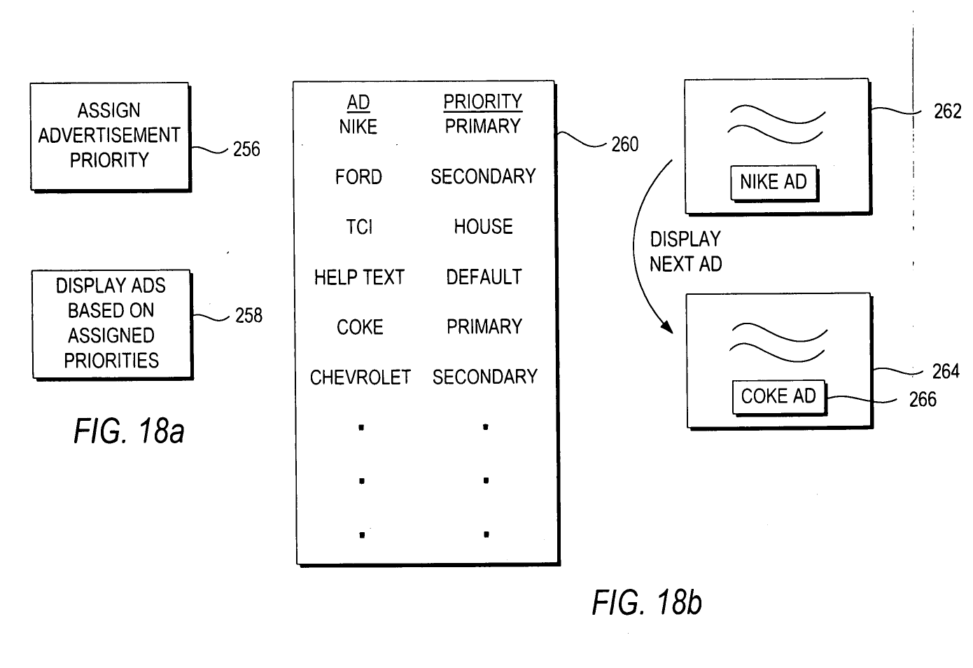

Interactive advertisements may be displayed based on priority. Illustrative steps involved in displaying advertisements based on priority for an interactive television system such as interactive television program guide system 50 of FIG. 1 are shown in FIG. 18a. At step 256, interactive advertisements may be assigned an advertisement priority. For example, an advertisement may be assigned a priority of primary, secondary, bonus, house, or default. At step 258, advertisements may be displayed based on their assigned priorities.

As shown in FIG. 18b, a data table 260 may be used to store priorities for a group of advertisements. Display screens 262 and 264 may include advertisements based on the priority information stored in data table 260. In data table 260, the advertisements for Nike and Coke have been assigned primary priority while the other advertisements have been assigned a lower priority. Primary priority advertisements are typically intended for display in a specific day part. In operation, display screen 262 may be displayed to include the primary priority Nike advertisement. When display screen 264, the next display screen, is displayed, the next primary priority advertisement in data table 260, Coke advertisement 266, may be displayed.

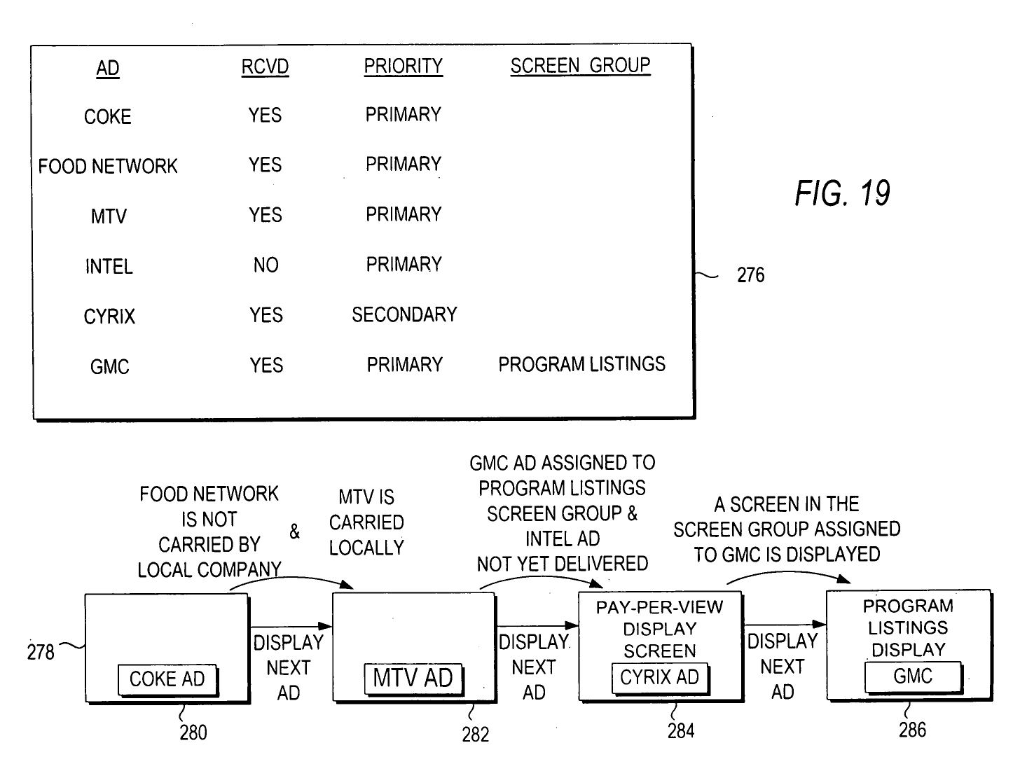

Interactive advertisements may be displayed based on priority in combination with other advertisement-related information. For example, as shown in FIG. 19, data table 276 may store assigned advertisement priority, screen group, and reception status for Coke, Food Network, MTV, Intel, Cyrix, and GMC advertisements. In operation, the display screen 278 may be displayed with the Coke advertisement 280 that has a primary priority. The next advertisement may be the primary priority advertisement for the Food Network. However, the advertisement for the Food Network may not be displayed because the Food Network may not be carried by the local television provider. The next advertisement may then be the primary advertisement for MTV. MTV is carried by the local provider and the MTV advertisement is displayed next in display screen 282 after Coke advertisement 280 has been displayed. The next advertisement may be the primary advertisement for Intel. However, data table 276 indicates that the Intel advertisement has not yet been received and therefore cannot be displayed. The next advertisement may then be the next available primary advertisement which is the advertisement for GMC. Data table 276 indicates that the GMC advertisement is assigned to a program listings screen group while the other advertisements have not been assigned a screen group. The next program guide display screen which is accessed by the user is a pay-per-view display screen 284, which is typically not a display screen in the program listings screen group. Therefore, the GMC advertisement is not available for display when the user accesses display screen 284. Since there are no primary advertisements that are available to be displayed in display screen 284, the program guide may display advertisements having secondary priority. Therefore, display screen 284 may include the secondary priority advertisement for Cyrix. When the next display screen is displayed, the primary advertisement for GMC may now be displayed because display screen 286 is a program listing display screen, which is in the screen group assigned to the GMC advertisement.

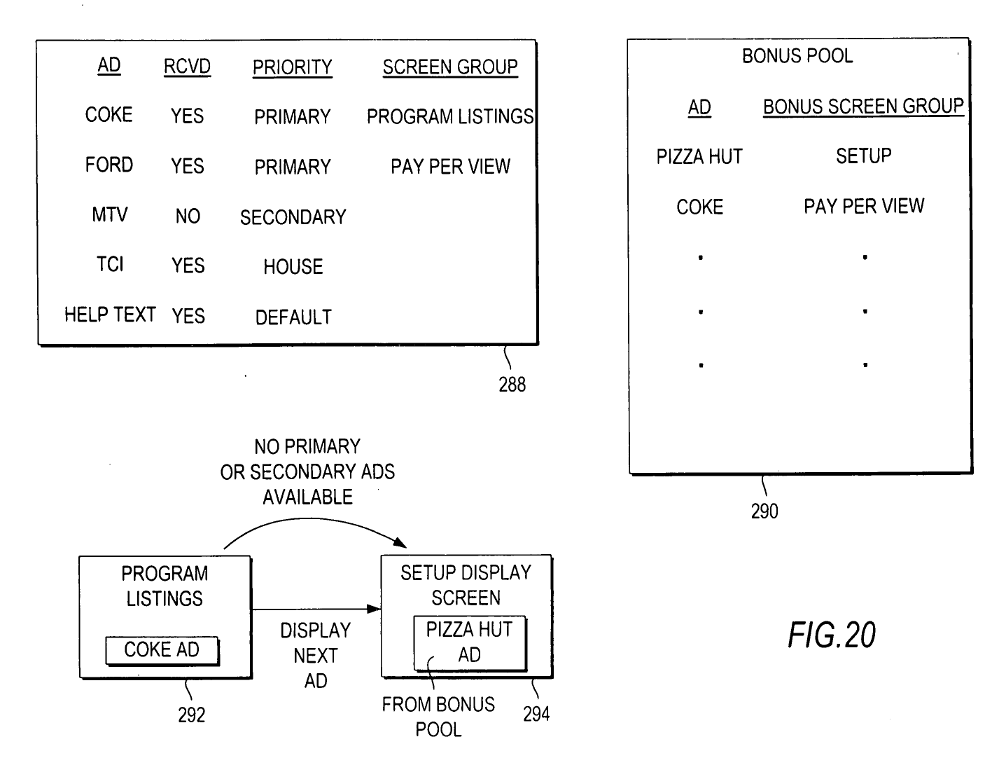

An advertisement may have been assigned more than one priority. For example, as shown in FIG. 20, an advertisement for Coke may have primary priority in data table 288 and have bonus priority in data table 290. A bonus priority may be provided as an enhancement to having a primary or secondary priority. A bonus priority may be assigned to increase the likelihood of a primary (or secondary) priority advertisement being displayed. A bonus priority advertisement may be displayed anytime when primary and secondary priority advertisements are not available. An advertisement may be assigned one screen group in combination with a primary (or secondary) priority and a different screen group in combination with a bonus priority. For example, the Coke advertisement in data tables 288 has been assigned a primary priority in combination with the program listings screen group and, the same Coke advertisement has been assigned bonus priority in combination with the pay-per-view screen group.

In operation, the Coke advertisement that was assigned primary priority and that was assigned to a program listing screen group may be displayed in program listings display screen 292. The system may determine from data table 288 that the primary priority advertisement for Ford has been assigned to a different screen group and that the secondary priority advertisement for MTV has not yet been successfully received. The information stored in data table 288 also indicates that the other available advertisements have a lower priority than bonus. When a user next accesses setup display screen 294, since no primary or secondary advertisements are available, an advertisement having bonus priority may be displayed in setup display screen 294 (e.g., the Pizza Hut advertisement).

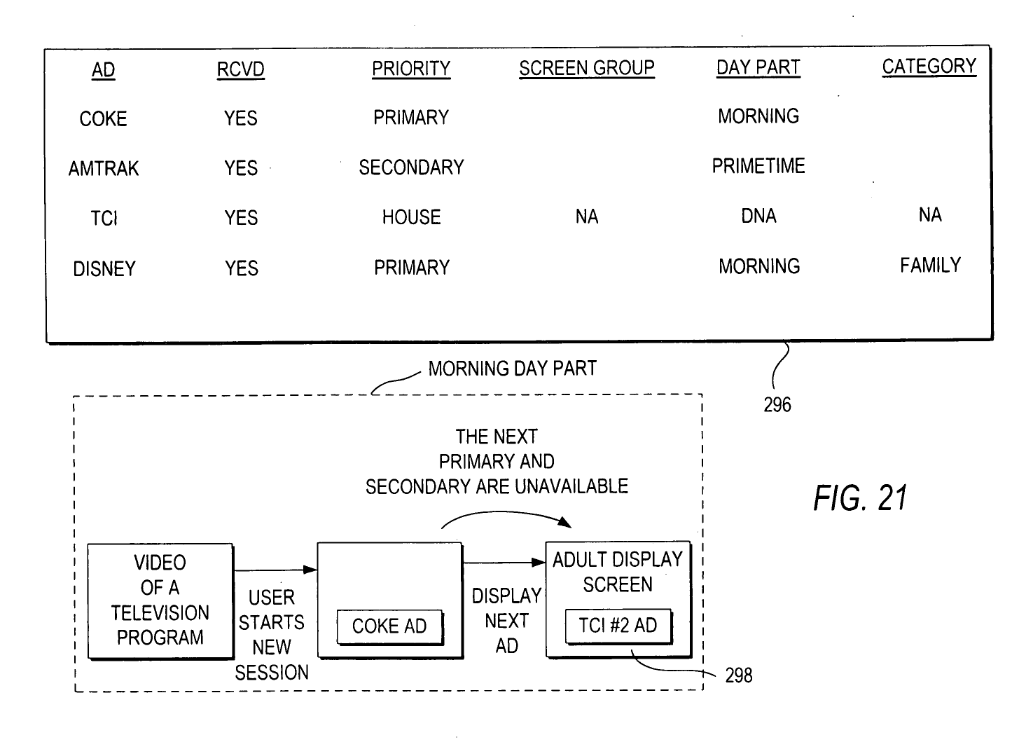

Interactive advertisements may have an assigned priority without having an assigned screen group, day part, or category. For example, as shown in FIG. 21, the information stored in data table 296 provides that the advertisement for TCI has house priority and that screen group, day part, and category are not applicable to the TCI house priority advertisement. Depending on the circumstances, however, screen group, day part, category, etc. may applicable to house priority advertisements. An advertisement having house priority may typically be a self-promoting advertisement that may be displayed when higher priority advertisements (primary, secondary, bonus) are unavailable. In operation according to data table 296, adult display screen 298 may include the advertisement for TCI because no primary, secondary, or bonus advertisements are available for display. The advertisement for Coke has already been displayed. The advertisement for Amtrak is unavailable because of being scheduled for a different day part and the advertisement for Disney is unavailable because the Disney advertisement is a family category advertisement which may not be displayed in adult display screen 298.

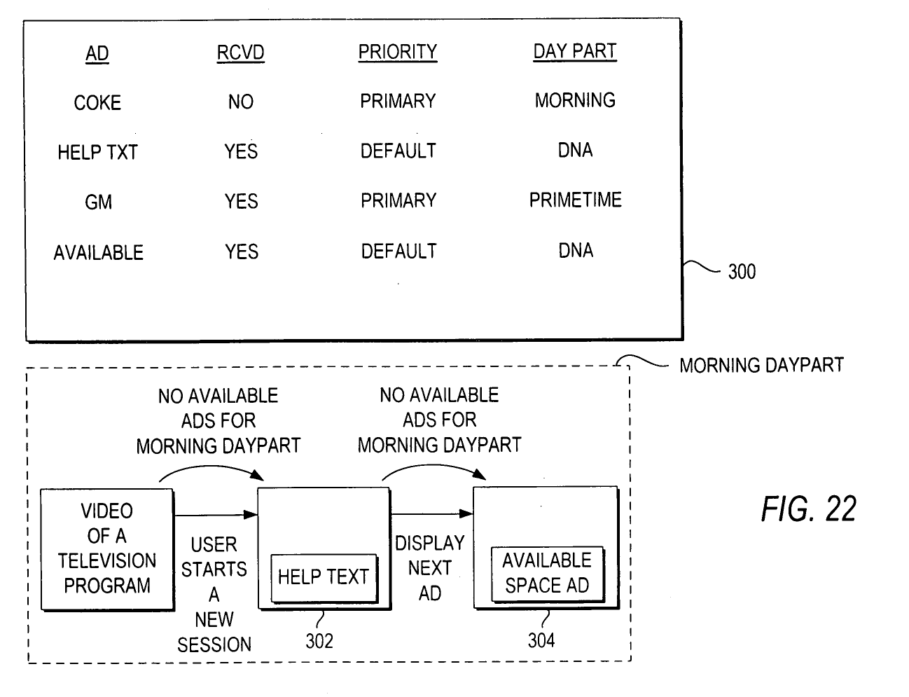

It is to be understood that for the purpose of scheduling interactive advertisements, interactive advertisements include interactive displays which provide user help information or draw attention to advertising space. Interactive displays that provide user help information or draw attention to advertising space may be assigned a default priority. Default priority advertisements may reside at user television equipment (e.g., as part of the application code at set-top box 70 of FIG. 1) and may only be displayed if no other advertisements are available. For example, as shown in FIG. 22, the information stored in data table 300 provides that the interactive advertisements for “Help Text” and “Available Space” have default priority and that a day part may not be applicable to default priority advertisements. In operation according to data table 300, display screens 302 and 304 include the default priority “Help Text” and “Available Space” advertisements (respectively) because the other advertisements of higher priority have not been received yet or are scheduled for a different day part. Advertisements such as default priority advertisements may be distributed separate from other advertisements. For example, default priority advertisements may be received and stored earlier for repeated presentation over several day parts, weeks, months, etc. Default priority advertisements may be stored as part of the application or as part of non-volatile memory.

If desired, advertisements which has been assigned a priority lower than primary (e.g., secondary, bonus, house, etc.) may displayed as substitutes for primary advertisements. For example, in situation where a period of time is available for primary priority advertisement but a primary priority advertisement has not been assigned, a lower priority advertisement may be displayed as a primary substitute. Within each level of priority, advertisements may be grouped in a rotation order.

A rotation order is typically a continuous loop rotation order (e.g., the starting point in the rotation is reached when the last advertisement in the rotation is displayed or is unavailable).

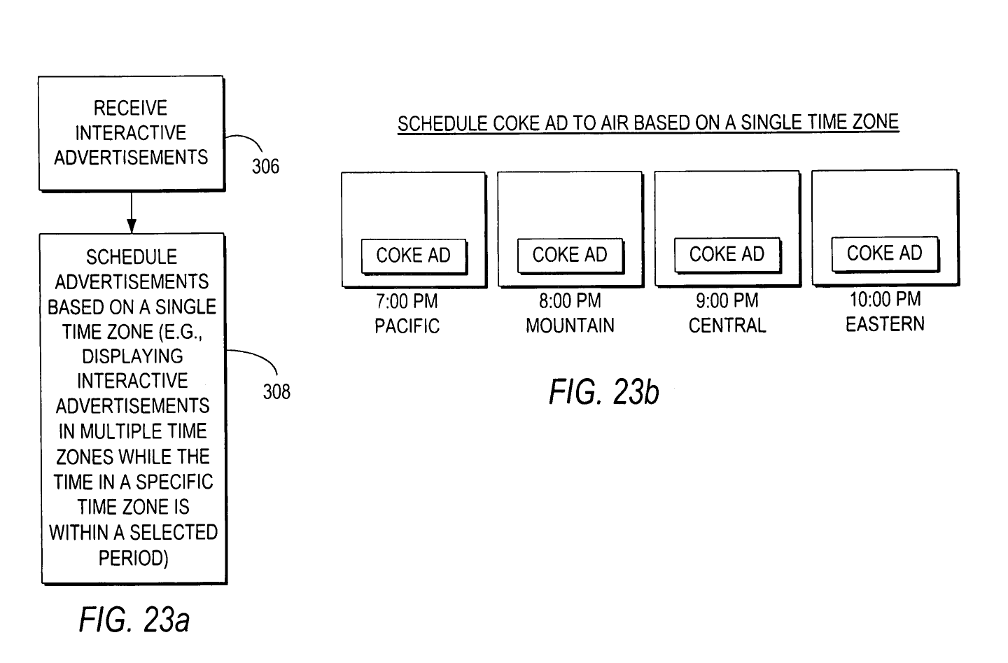

Interactive advertisements may be scheduled across multiple time zones (e.g., nationally) based on a single time zone. For an interactive television system such as interactive television program guide system 50 of FIG. 1, illustrative steps involved in scheduling interactive advertisements across multiple time zones based on a single time zone are shown in FIG. 23a. At step 306, interactive advertisements may be received for presentation to users. At step 308, interactive advertisements may be scheduled for presentation in multiple time zones based on a single time zone. For example, as show in FIG. 23b, an advertisement for Coke may be assigned to a 5:00-8:00 PM Pacific time zone day part and displayed in the Pacific time zone and other times zones while the time in the Pacific time zone is within the 5:00-8:00 PM time period (e.g., within 6:00-9:00 PM Mountain time, 7:00-10:00 PM Central time, and 8:00-11:00 PM Eastern time). An advantage of such a scheduling technique is that advertisements may only have to be broadcast once for all systems (e.g., broadcast once to multiple television distribution facilities across various time zones).

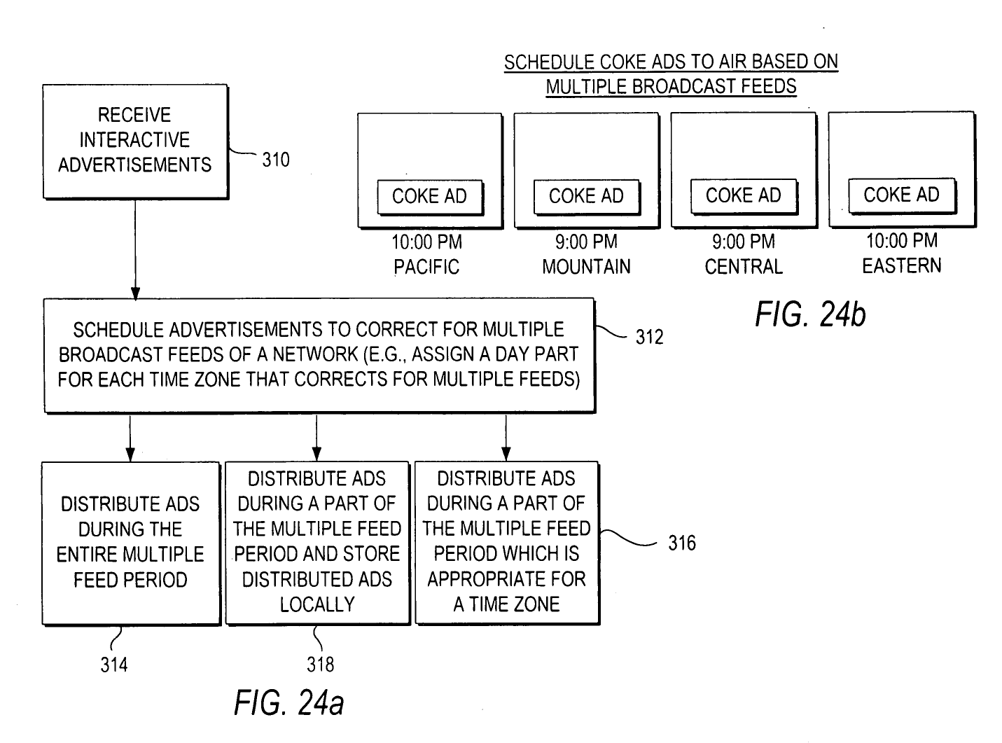

If desired, interactive advertisements may be scheduled across multiple time zone based on multiple network broadcast feeds. Illustrative steps involved in scheduling interactive advertisements for an interactive television system such as interactive television program guide system 50 of FIG. 1, based on multiple network broadcast feeds are shown in FIG. 24a. At step 310, interactive advertisements may be received for presentation to users. At step 312, interactive advertisements may be scheduled in different time zones to correct for multiple broadcast feeds of a network. At step 314, advertisements may be distributed during an entire period for correcting multiple broadcast feeds. If desired, at step 316, advertisements may be distributed during part of the period for correcting multiple broadcast feeds which is appropriate for each time zone. Also if desired, at step 318, advertisements may be distributed during a part of the multiple feed period and then stored locally for distribution to user television equipment (e.g., user television equipment 66 of FIG. 1). For example, as shown in FIG. 24b, an advertisement for Coke may have been scheduled to correct for multiple broadcast feeds. The Coke advertisement may have been assigned a day part for each time zone that corrects for multiple broadcasts feeds of a network (e.g., an 8:00-11:00 PM Pacific time day part, a 7:00-10:00 PM Mountain time day part, a 7:00-10:00 PM Central time day part, and an 8:00-11:00 PM Eastern time day part). A main facility such as main facility 52 of FIG. 1 may distribute advertisements during the entire time span of the assigned day parts (e.g., from 8:00 PM to 2:00 AM Eastern time). If desired, the advertisements may be received and displayed during the local day part (e.g., 8:00-11:00 PM Pacific time day art). If desired, the advertisements may be distributed during a subset of the entire time span and may be stored locally for display during the local day part (e.g., distribute to all time zones during the 7:00-10:00 PM Mountain time day part).

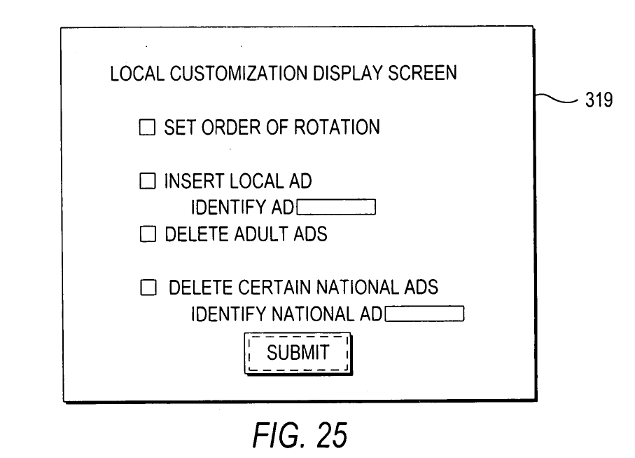

The scheduling of local advertisements and local control over national advertisements may also be provided. Illustrative local customization display screen 319 of FIG. 25 may allow control over local insertion or customization of advertisements. Display screen 319 may include a selectable option for setting or modifying the rotation order of advertisements. When selected, a user may be provided with an opportunity to set a rotation order for the display of advertisements or to modify an existing advertisement sequence.

Display screen 319 may include an insert local advertisement option. When selected, the user may be provided with the opportunity to identify the local advertisement (e.g., identify an advertisement file location) that is to be inserted into the schedule. Display screen 319 may include a delete adult advertisements option, which when selected deletes adult content advertisements from the schedule in a locality. Display screen 319 may include a delete advertisement option, which when selected provides the user with the opportunity to specify a national advertisement which is to be deleted from the schedule.

Local customization display screen 319 may be provided at a local customer (e.g., local customer computer 88 of FIG. 1) or at a television distribution facility (e.g., local computer 62 of FIG. 1). Depending on the system architecture, the selections made from display screen 319 may be transmitted with other selection related information to a main facility or a television distribution facility via an Internet communications path or other suitable communications path.

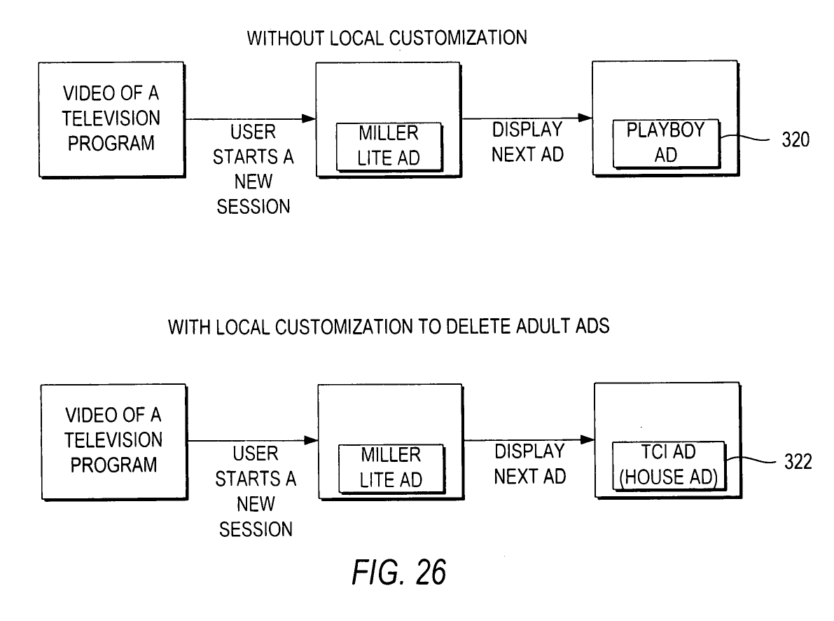

As shown in FIG. 26, when a user selects to delete adult-content advertisements from a schedule, an advertisement such as Playboy advertisement 320 may be deleted from the schedule and a house priority advertisement for TCI 322 may be shown instead.

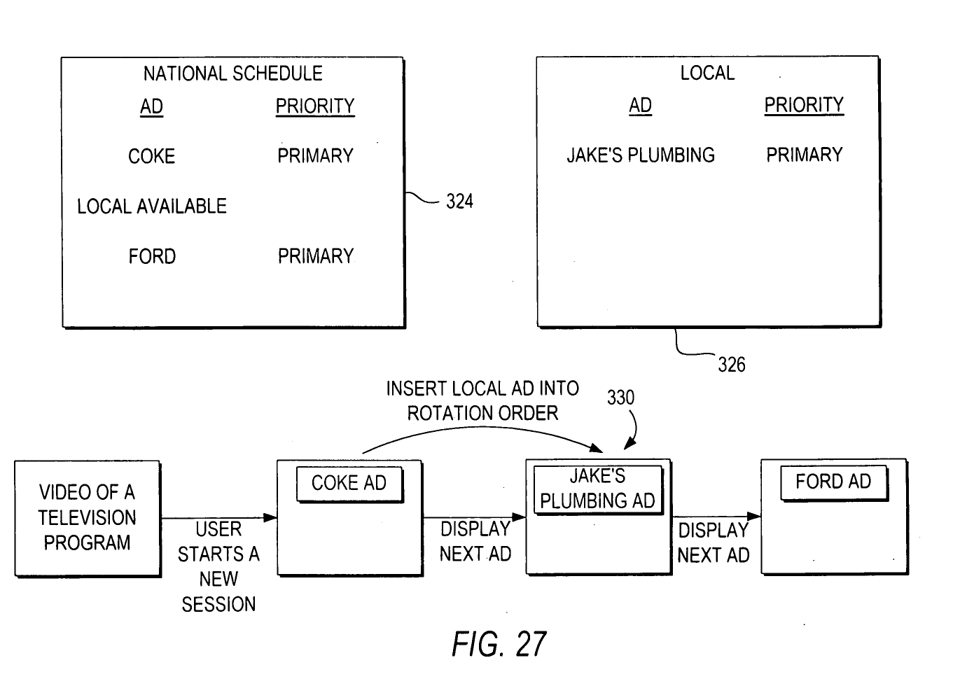

As shown in FIG. 27, information stored in data table 324 may include a national advertisement schedule for a particular day part. The national advertisement schedule may include a portion that has been left available for local advertisements. Local data table 326 may store information identifying local advertisements that may be inserted in the national advertisement schedule. For example, when display screen 330 is displayed at a point in the schedule (data table 324) where a space is available for the insertion of a local advertisement, the advertisement for Jake's Plumbing that is identified in data table 326 may be displayed. The local system programmer or system operator may distribute a local advertisement data stream, which would be monitored by the program guide in parallel with a national stream. The local stream may include local advertisements, local advertisement related information, and local customization related information.

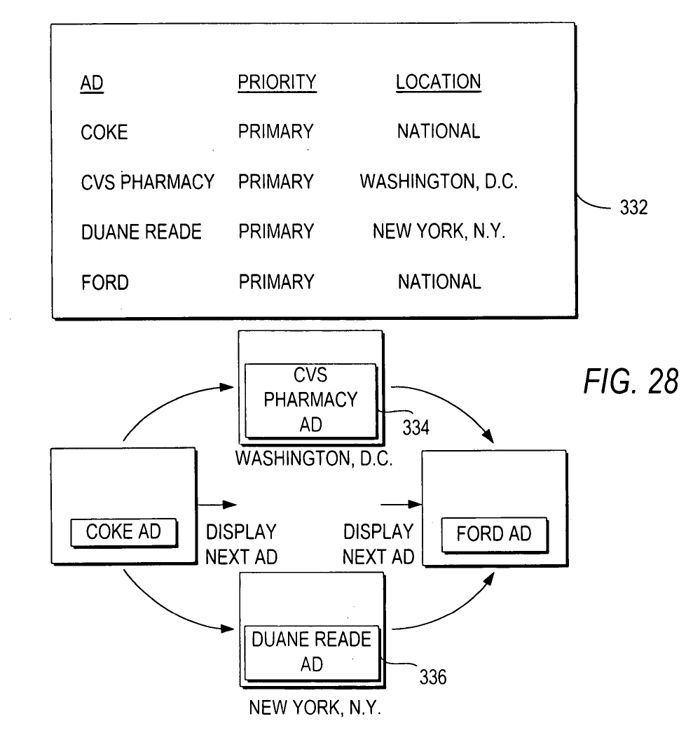

If desired, local advertisements may be included in a national distribution channel. The channel may include addressing information for identifying where local advertisements are to be displayed. For example, as shown in FIG. 28, data table 332 may include addresses for local advertisements for CVS Pharmacy and Duane Reade. The addresses indicate that the CVS Pharmacy advertisement is to be displayed in Washington and the Duane Reade advertisement is to be displayed in New York. In operation, when advertisements are displayed based on data table 332, the CVS Pharmacy advertisement 334 is displayed in the Washington area, and the Duane Reade advertisement 336 is displayed in the New York area.

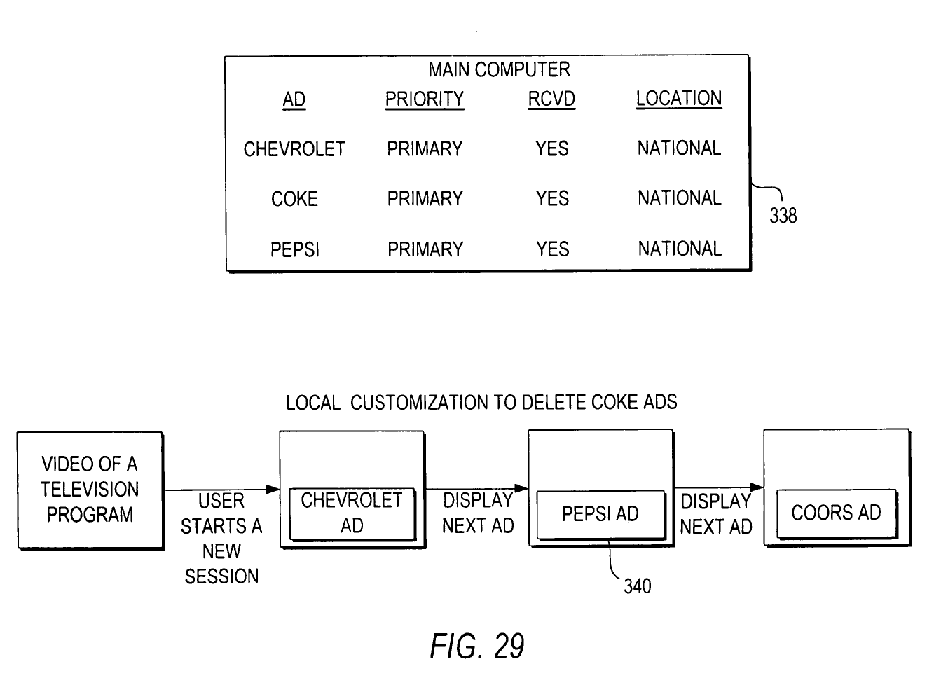

As explained above, local customization may include the removal of selected advertisements from the advertisement schedule. For example, as shown in FIG. 29, data table 338 may store information providing a national distribution schedule for advertisements for Coke, Chevrolet, Pepsi, etc. A user may have opted to delete advertisements for Coke from the schedule. Thus, when the program guide presents advertisements based on data table 338, the advertisement for Coke is removed from the schedule and the next scheduled advertisement, the Pepsi advertisement 340, may be displayed.

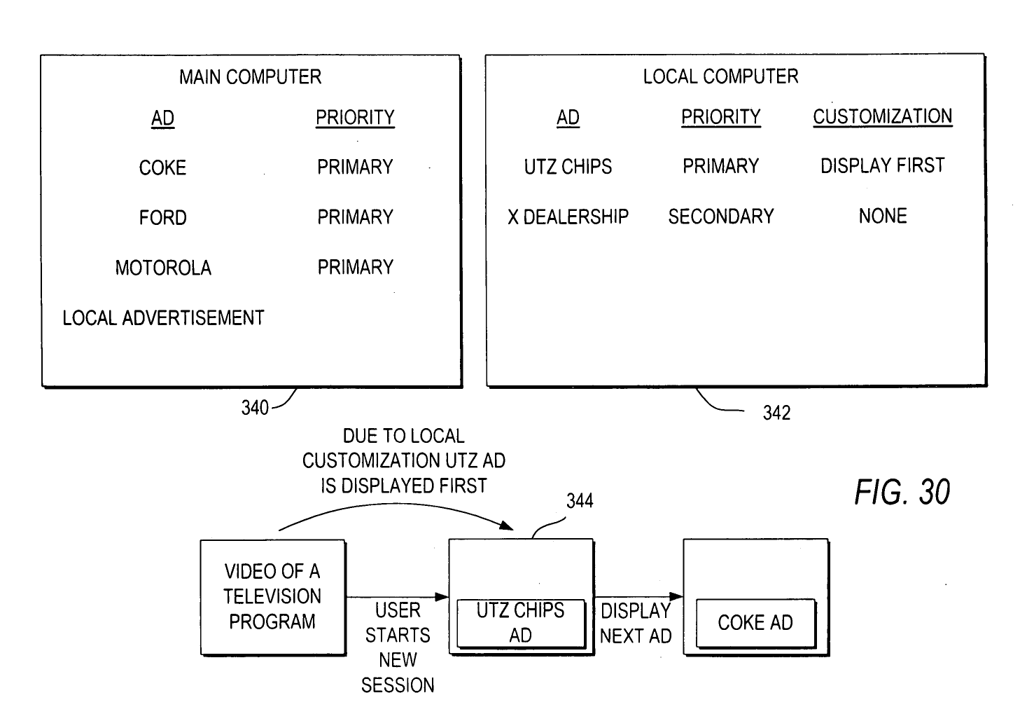

As explained above, local customization may set or modify the rotation order for advertisements. For example, as shown in FIG. 30, data table 340 may store a national schedule and data table 342 may store local customization-related information. The schedule in data table 340 may provide for the insertion of a local advertisement after the last national advertisement in the schedule is displayed. The local customization related information in data table 342 may indicate that the first displayed advertisement is to be a local advertisement for Utz Chips. In operation, when display screen 344 is displayed based on the national schedule (data table 342) and further based on the local customization related information, the local advertisement for Utz may be displayed first in the schedule.

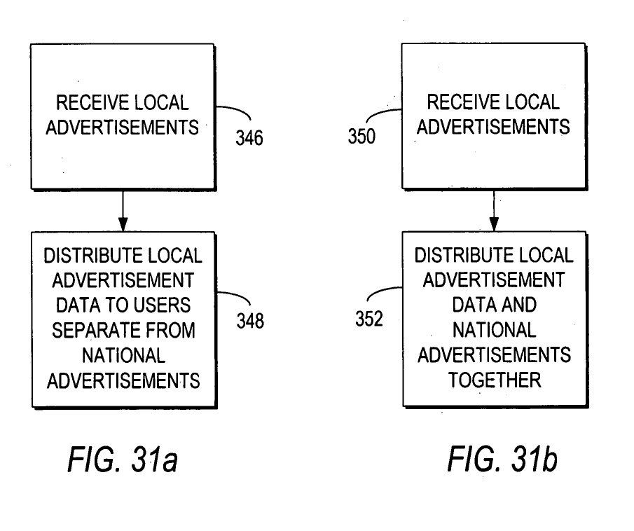

Illustrative steps involved in distributing local advertisements to user television equipment such as user television equipment 66 of FIG. 1 are shown in FIG. 31a. At step 346, local advertisements may be received for distribution. At 348, local advertisements may be distributed to users in a data stream separate from national advertisements. Illustrative steps involved in an alternative technique for distributing advertisements to user television equipment such as user television equipment 66 of FIG. 1 are shown in FIG. 31b. At step 350, local advertisements may be received for distribution. At step 352, local advertisements may be distributed in the same data stream as national advertisements.

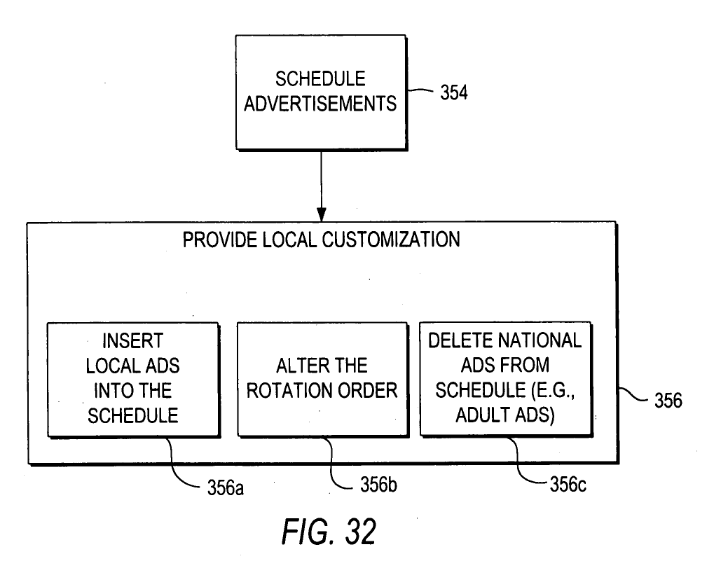

Illustrative steps involved in providing local customization for an interactive television system such as interactive television program guide system 50 of FIG. 1 are shown in FIG. 32. At step 354, advertisements may be scheduled for presentation to users. At step 356, local customization for scheduled advertisements may be provided. At step 356a, a local advertisement may be inserted into the schedule (e.g., as shown in FIG. 27). At step 356b, the rotation order for scheduled advertisements may be set (e.g., as shown in FIG. 30). At step 356c, certain national advertisement may be deleted from the schedule (e.g., as shown in FIG. 26 and FIG. 29).

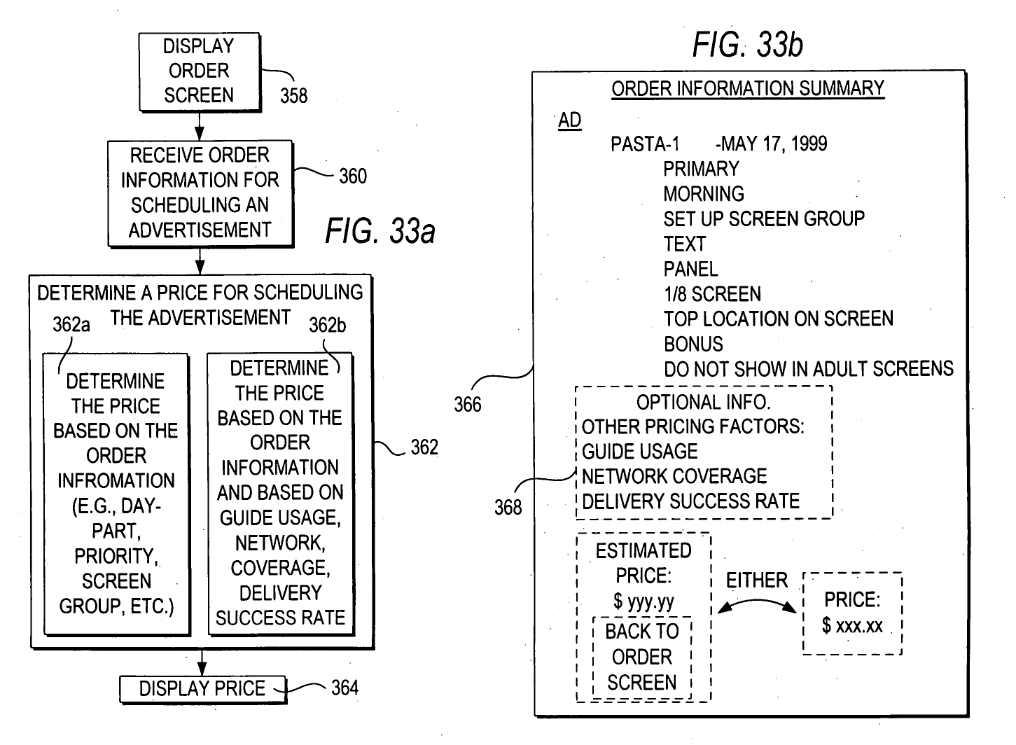

Interactive advertisements may be priced based on many factors. Illustrative steps involved in pricing interactive advertisement orders for an interactive television system such as interactive television program guide system 50 of FIG. 1 are shown in FIG. 33a. At step 358, an order entry display screen such as order entry display screen 100 of FIG. 3 may be displayed. At step 360, in response to displaying an order entry display screen, order information for scheduling an advertisement may be received. At step 362, a price for scheduling the advertisement may be determined. The price may be determined based on the order information (e.g., day part, priority, screen group, etc.) (step 362a). The price may also be determined based on program guide usage, network coverage, delivery success rate, etc., and the ordering information (step (362b)). At step 364, the price may be displayed.

For example, order information summary display screen 366 of FIG. 33b may provide pricing. Display screen 366 may provide a summary of advertisement order information and an option 368 for accessing other pricing information (e.g., guide usage, network coverage, delivery success rate, etc.). When option 368 is selected, other factors that were used in determining a price may be displayed or the user may be provided with an opportunity to select some of the other factors for determining price. Display screen 366 may also include a price or an estimated price for an order.

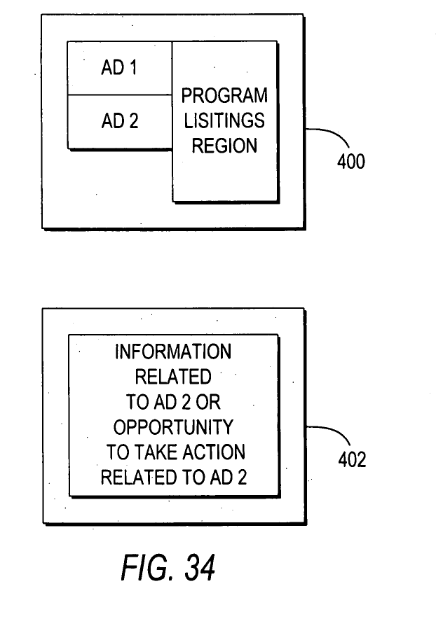

Typically, an interactive advertisement is an advertisement that is selectable or that may include selectable portions for receiving more information or for receiving opportunities to make further selections in connection with the selected advertisement. For example, as shown FIG. 34, the program guide may display interactive advertisement “Ad 2” in display screen 400. When a user selects “Ad 2” (e.g., by positioning a highlight region on “Ad 2” and pressing a data entry key), display screen 402 may be displayed. Display screen 402 may include information related to “Ad 2” or may include an opportunity to take action related to “Ad 2.”

It is to be understood that although the present invention is sometimes primarily discussed in the context of a program guide application, the present invention is not limited to program guide applications or interactive television program guide systems. Other interactive television systems and other interactive television applications such as a home shopping application that displays advertisements on user television equipment may include features of the present invention. In addition, although the invention has been described primarily in the context of user television equipment (i.e., equipment with processing and video display capabilities), aspects of the invention are also applicable to computer equipment and the like that need not have video capabilities. Thus, interactive applications running on personal computers may display interactive advertisements that are scheduled using the techniques described herein if desired.

The foregoing is merely illustrative of the principles of this invention and various modifications can be made by those skilled in the art without departing from the scope and spirit of the invention.

What is claimed is:

1. In a system for scheduling advertisements for presentation to users on their television equipment, a method comprising:
receiving a plurality of digital interactive advertisements;
receiving electronic orders from customers for certain interactive advertisements that the customers desire to have displayed to the users; and
scheduling how the interactive advertisements are displayed on the television equipment of the users based on the electronic advertisement orders.

2. The method defined in claim 1, wherein receiving a plurality of digital interactive advertisements includes receiving a plurality of digital interactive advertisements at a main computer at a main facility.

3. The method defined in claim 1, wherein receiving a plurality of digital interactive advertisements includes receiving a plurality of digital interactive advertisements at a local computer at a television distribution facility.

4. The method defined in claim 1, wherein receiving electronic orders includes receiving electronic orders at a main computer at a main facility.

5. The method defined in claim 1, wherein receiving electronic orders includes receiving electronic orders at a local computer at a television distribution facility.

6. The method defined in claim 1, wherein scheduling includes scheduling by user television equipment.

7. The method defined in claim 1, wherein receiving a plurality of digital interactive advertisements includes receiving the advertisements via an Internet communications connection.

8. The method defined in claim 1, wherein receiving electronic orders includes receiving the orders via an Internet communications connection.

9. The method defined in claim 1, further comprising determining a price for electronic orders.

10. The method defined in claim 1, further comprising determining a price for electronic orders based on electronic order information included in each electronic order.

11. The method defined in claim 1, further comprising determining a price for electronic orders based on how the interactive advertisements are scheduled to be displayed.

12. The method defined in claim 1, further comprising determining a price for electronic orders based on how the interactive advertisements are scheduled to be displayed and based on delivery success rates.

13. In a system in which interactive advertisements are displayed for users in an interactive television application running at least partially on user television equipment, wherein the interactive television application displays screens on the user television equipment, and wherein related screens are grouped into various screen groups, a method comprising:
receiving orders for interactive advertisements to be displayed with the interactive television application;
assigning priorities to each of the interactive advertisements;
assigning each of the interactive advertisements to one of the screen groups; and
displaying the interactive advertisements with the interactive television application, wherein each advertisement is displayed on one of the screens in the group to which that interactive advertisement is assigned, and wherein the interactive advertisements that are displayed on a screen in a given screen group are displayed based on their assigned priorities.

14. The method defined in claim 13, wherein the interactive television application is an interactive television program guide application, and displaying includes displaying the interactive advertisements with the interactive television program guide application.

15. The method defined in claim 13, wherein assigning priorities includes assigning to at least one of the interactive advertisement more than one priority.

16. The method defined in claim 13, wherein assigning priorities includes assigning to at least one of the interactive advertisements more than one priority; and wherein assigning screen groups includes assigning a screen group in combination with each assigned priority.

17. In a system in which interactive advertisements are displayed for users in an interactive television application running at least partially on user television equipment, a method comprising:
receiving orders for interactive advertisements to be displayed with the interactive television application;
assigning each interactive advertisement to a day part; and
displaying the interactive advertisements with the interactive television application based on the assigned day part.

18. The method defined in claim 17, wherein the interactive television application is an interactive television program guide application, and displaying includes displaying the interactive advertisements with the interactive television program guide application.

19. The method defined in claim 17, wherein the orders include information on a desired day part.

20. The method defined in claim 17, wherein assigning includes assigning day parts based on the received orders.
